(19) United States
(12) Patent Application Publication
(10) Pub. No.: US 2015/0339575 A1
(43) Pub. Date: Nov. 26, 2015

(54) INFERENCE ENGINE

(71) Applicant: Open Inference LLC, Rockville, MD (US)

(72) Inventor: Scott STREIT, Woodbine, MD (US)

(73) Assignee: Open Inference LLC, Rockville, MD (US)

(21) Appl. No.: 14/284,050

(22) Filed: May 21, 2014

(51) Int. Cl. G06N 5/04; G06F 17/30

(52) U.S. Cl. CPC G06N 5/04; G06F 17/30867; G06F 17/30876; G06F 17/30731

(57) ABSTRACT

System, program product and method for generating entailments, the system comprising an input component to obtain input data; a comparator comparing input data to a group of term sets comprising key words, definitions, and relationships for areas of interest; a term selector to select terms and load into memory; an inference rule selector to select, based on selected terms and input data, inference rules; a historical data selector to select, based on the selected terms and the selected inference rules, a subset of historical data; a rules engine to generate new entailments based on the input data, subset of historical data, selected terms, and inference rules; repeating steps for each entailment; a storing component to store the input data and new entailments; obtaining output data based on the input data, the new entailments, the subset of historical data, the output data, for user utilization.

### BACKGROUND

As systems become larger and more complex due to the distributed nature of the Internet and deal with ever larger volumes of data, the solutions developed frequently fail or demand enormous overhead to function. The surge in complexity derives from changing requirements as well as the changing structure of the data and the relationship between the two.

For such problems, relational processing allowed highly concurrent access to data modeled in a normalized fashion. This processing typifies typical accounting or other well defined systems. However, many of today's problems are so chaotic that a fixed structure for a problem cannot be defined. As problems gain in complexity, solutions must embrace this chaos. Included with chaotic processing is the desire to retrieve the data in rapid fashion, irrespective of machine or software failures.

### SUMMARY OF THE INVENTION

A non-transitory computer-readable medium with computer instructions therein for generating entailments when the computer instructions are executed by one or more computers. In embodiments, the computer instructions may comprise the steps: (a) obtaining, by the one or more computers, via one or more communication networks, input data of a user comprising one or more selected from the group of calendar events, GPS data, social network activity, search queries, and user preferences, where the input data may be semantically structured and/or non-semantically structured; (b) comparing, by the one or more computers, the input data to a group of term sets, where a term set comprises one or more selected from the group of key words, definitions, and relationships for an area of interest; (c) determining, by the one or more computers, based at least in part on results of the comparing step, selected terms, where the selected terms comprise a plurality of key words and/or definitions and/or relationships from the group of term sets, and loading the selected terms into memory, which is non-persistent; (d) selecting, by the one or more computers, based at least in part on the selected terms and the input data, a plurality of inference rules from a rules resource, and loading the plurality of inference rules into the memory; (e) selecting, by the one or more computers, based at least in part on the selected terms and the plurality of inference rules from a historical user data datastore, a subset of historical user data comprising past input data of the user and previously generated entailments of the user, where an entailment is an automatically-machine-generated conclusion of an inference rule, and loading the subset of the historical user data into the memory; (0 generating by firing one or more of the inference rules, using a rules engine configured in the one or more computers, one or more new entailments based at least in part on the input data, the subset of historical user data, the selected terms, and the inference rules; (g) when a new entailment is generated, repeating steps (a)-(f), for each entailment generated, treating the new entailment as input data in the performance of the steps; (h) storing or having stored, by the one or more computers, in the historical user data datastore as historical user data of the user, the input data and all new entailments; (i) obtaining, by the one or more computers, via the one or more communication networks, output data comprising one or more from the group of points of interest along a route, predictive routes, and inferred destinations, based at least in part on the input data, the new entailments, the subset of historical user data, and GPS data; and (j) sending or having sent, by the one or more computers, via the one or more communication networks, the output data to a display for user utilization.

In embodiments, the input data and the historical user data may comprise data for a network intrusion security application, and the output data may comprise whether a machine is blacklisted and denied access or allowed access.

In embodiments, the input data and the historical user data may comprise data for a medical diagnosis application, and the output data may comprise health risk summary and health profile.

In embodiments, the input data and the historical user data may comprise data for a genetic pattern analysis application, and the output data may comprise summarized genetic patterns and set of genetic pattern.

In embodiments, the input data and the historical user data may comprise data for an unmanned vehicle application, and the output data may comprise points of interest and predicted routes.

In embodiments, the input data and the historical user data may comprise data for an application with a massive amount of stored data, and the output data may comprise selected data generated by inference.

In embodiments, the input data may comprise three or more selected from the group of calendar events, GPS data, social network activity, search queries, and user preferences.

In embodiments, the input data may comprise all from the group of calendar events, GPS data, social network activity, search queries, and user preferences.

In embodiments, the term set may comprise key words, definitions, and relationships for an area of interest.

In embodiments, the selected terms may comprise key words, definitions, and relationships from the group of term sets.

In embodiments, the non-transitory computer-readable medium may further comprise computer instructions for instantiating, by the one or more computers, semantically structured input data, based at least in part on the selected terms and non-semantically-structured input data.

In embodiments, the input data and all new entailments may be stored as historical user data of the user tagged with provenance.

In embodiments, the output data may further comprise one or more from the group of calendar event reminders and reordered search results, obtained by the one or more computers, based at least in part on the input data, the new entailments, the subset of historical user data, and the GPS data.

In embodiments, the GPS data may comprise route segment data, wherein a route segment comprises a GPS start point and a GPS end point.

In embodiments, a non-transitory computer-readable medium is disclosed with computer instructions therein for creating a route when the computer instructions are executed by one or more computers. In embodiments, the computer instructions may comprise the steps: (a) obtaining, by one or more computers, via one or more communication networks, a first GPS point of a user; (b) obtaining, by the one or more computers, via the one or more communication networks, based on a GPS point obtained most recently, one or more route segments, where a route segment comprises a GPS start point and a GPS end point; (c) loading, by the one or more computers, the one or more route segments into memory; (d) obtaining, by the one or more computers, via the one or more communication networks, a present GPS point of the user that is subsequent in time to the first GPS point of the user; (e) comparing, by the one or more computers, the present GPS point to each of the route segments in memory; (f) removing, by the one or more computers, from memory, each route segment for which results of the comparing step of (e) indicate the present GPS point is not located on that route segment; (g) repeating steps (d)-(g), until results of the comparing step of (e) indicate the present GPS point is located on only a single one of the route segments in memory; (h) adding, by the one or more computers, the single route segment as part of a series of route segments representing an actual route; (i) executing, by the one or more computers, an algorithm that determines whether a destination has been reached; (j) repeating steps (b)-(j), while results of the executing step of (i) indicate the destination has not been reached; and (k) storing or having stored, by the one or more computers, as historical user data tagged with provenance, the series of route segments as a previous route in a historical user data datastore.

In embodiments, the non-transitory computer-readable medium may further comprise: (n) comparing, by the one or more computers, the first GPS point of the user with an origin point of each previous route of the user, where a previous route is historical user data of a user comprising a series of route segments in which a GPS end point of one route segment is a GPS start point of another route segment, and where an origin point of a route is a GPS start point of a route segment beginning the series of route segments; (o) determining, by the one or more computers, based at least in part on the comparison, a plurality of previous routes whose origin points are within a threshold of the first GPS point of the user, and loading the plurality of previous routes into memory; (p) calculating, by the one or more computers, an inferred route, based at least in part on calendar events of the user, time of day, previous routes in memory, number of times each previous route in memory was taken, and/or user preferences; (q) obtaining, by the one or more computers, via the one or more communication networks, a plurality of points of interest based on the inferred route and historical user data of the user; (r) sending, by the one or more computers, via the one or more communication networks, the inferred route, the previous routes in memory, an inferred destination, which is a route segment ending the series of route segments of the inferred route, and the plurality of points of interest to a display for user utilization; (s) comparing, by the one or more computers, the single route segment with the route segments of the inferred route and of each of the previous routes in memory; (t) removing, by the one or more computers, from memory any route which does not contain the single route segment; and repeating steps (p)-(r); and (u) repeating steps (s)-(t) whenever results of the comparing step of (e) indicate the present GPS point is located on only a single one of the route segments in memory.

In embodiments, a system for generating entailments may comprise: one or more computers configured to: (a) obtain, using an input component configured in the one or more computers, via one or more communication networks, input data of a user comprising one or more selected from the group of calendar events, GPS data, social network activity, search queries, and user preferences, where the input data may be semantically structured and/or non-semantically structured; (b) compare, using a comparator configured in the one or more computers, the input data to a group of term sets, where a term set comprises one or more selected from the group of key words, definitions, and relationships for an area of interest; (c) determine, using a term selector configured in the one or more computers, based at least in part on results of the comparing step, selected terms, where the selected terms comprise a plurality of key words and/or definitions and/or relationships from the group of term sets, and loading the selected terms into memory, which is non-persistent; (d) select, using an inference rule selector configured in the one or more computers, based at least in part on the selected terms and the input data, a plurality of inference rules from a rules resource, and loading the plurality of inference rules into the memory; (e) select, using a historical data selector configured in the one or more computers, based at least in part on the selected terms and the plurality of inference rules from a historical user data datastore, a subset of historical user data comprising past input data of the user and previously generated entailments of the user, where an entailment is an automatically-machine-generated conclusion of an inference rule, and loading the subset of the historical user data into the memory; (f) generate by firing one or more of the inference rules, using a rules engine configured in the one or more computers, one or more new entailments based at least in part on the input data, the subset of historical user data, the selected terms, and the inference rules; (g) when a new entailment is generated, repeat steps (a)-(f), for each entailment generated, treating the new entailment as input data in the performance of the steps; (h) store or have stored, by the one or more computers, in the historical user data datastore as historical user data of the user, the input data and all new entailments; (i) obtain, by the one or more computers, via the one or more communication networks, output data comprising one or more from the group of points of interest along a route, predictive routes, and inferred destinations, based at least in part on the input data, the new entailments, the subset of historical user data, and GPS data; and (j) send or have sent, by the one or more computers, via the one or more communication networks, the output data to a display for user utilization.

In embodiments, the input data may comprise three or more selected from the group of calendar events, GPS data, social network activity, search queries, and user preferences.

In embodiments, the input data may comprise all from the group of calendar events, GPS data, social network activity, search queries, and user preferences.

In embodiments, the selected terms comprise key words, definitions, and relationships from the group of term sets.

In embodiments, the GPS data comprises route segment data, wherein a route segment may comprise a GPS start point and a GPS end point.

In embodiments, a system for creating a route when the computer instructions are executed is disclosed. In embodiments, the system may comprise: one or more computers, configured with computer instructions to: (a) obtain, by the one or more computers, via one or more communication networks, a first GPS point of a user; (b) obtain, by the one or more computers, via the one or more communication networks, based on a GPS point obtained most recently, one or more route segments, where a route segment comprises a GPS start point and a GPS end point; (c) load, by the one or more computers, the one or more route segments into memory; (d) obtain, by the one or more computers, via the one or more communication networks, a present GPS point of the user that is subsequent in time to the first GPS point of the user; (e) compare, by the one or more computers, the present GPS point to each of the route segments in memory; (f) remove, by the one or more computers, from memory, each route segment for which results of the comparing step of (e) indicate the present GPS point is not located on that route segment; (g) repeat steps (d)-(g), until results of the comparing step of (e) indicate the present GPS point is located on only a single one of the route segments in memory; (h) add, by the one or more computers, the single route segment as part of a series of route segments representing an actual route; (i) execute, by the one or more computers, an algorithm that determines whether a destination has been reached; (j) repeat steps (b)-(j), while results of the executing step of (i) indicate the destination has not been reached; and (k) store or have stored, by the one or more computers, as historical user data tagged with provenance, the series of route segments as a previous route in a historical user data datastore.

In embodiments, the system may further comprise the one or more computers configured to: (n) compare, by the one or more computers, the first GPS point of the user with an origin point of each previous route of the user, where a previous route is historical user data of a user may comprise a series of route segments in which a GPS end point of one route segment is a GPS start point of another route segment, and where an origin point of a route is a GPS start point of a route segment beginning the series of route segments; (o) determine, by the one or more computers, based at least in part on the comparison, a plurality of previous routes whose origin points are within a threshold of the first GPS point of the user, and loading the plurality of previous routes into memory; (p) calculate, by the one or more computers, an inferred route, based at least in part on calendar events of the user, time of day, previous routes in memory, number of times each previous route in memory was taken, and/or user preferences; (q) obtain, by the one or more computers, via the one or more communication networks, a plurality of points of interest based on the inferred route and historical user data of the user; (r) send, by the one or more computers, via the one or more communication networks, the inferred route, the previous routes in memory, an inferred destination, which is a route segment ending the series of route segments of the inferred route, and the plurality of points of interest to a display for user utilization; (s) compare, by the one or more computers, the single route segment with the route segments of the inferred route and of each of the previous routes in memory; (t) remove, by the one or more computers, from memory any route which does not contain the single route segment; and repeating steps (p)-(r); and (u) repeat steps (s)-(t) whenever results of the comparing step of (e) indicate the present GPS point is located on only a single one of the route segments in memory.

In embodiments, a method for generating entailments may comprise: (a) obtaining, by one or more computers, via one or more communication networks, input data of a user comprising one or more selected from the group of calendar events, GPS data, social network activity, search queries, and user preferences, where the input data may be semantically structured and/or non-semantically structured; (b) comparing, by the one or more computers, the input data to a group of term sets, where a term set comprises one or more selected from the group of key words, definitions, and relationships for an area of interest; (c) determining, by the one or more computers, based at least in part on results of the comparing step, selected terms, where the selected terms comprise a plurality of key words and/or definitions and/or relationships from the group of term sets, and loading the selected terms into memory, which is non-persistent; (d) selecting, by the one or more computers, based at least in part on the selected terms and the input data, a plurality of inference rules from a rules resource, and loading the plurality of inference rules into the memory; (e) selecting, by the one or more computers, based at least in part on the selected terms and the plurality of inference rules from a historical user data datastore, a subset of historical user data comprising past input data of the user and previously generated entailments of the user, where an entailment is an automatically-machine-generated conclusion of an inference rule, and loading the subset of the historical user data into the memory; (f) generating by firing one or more of the inference rules, using a rules engine configured in the one or more computers, one or more new entailments based at least in part on the input data, the subset of historical user data, the selected terms, and the inference rules; (g) when a new entailment is generated, repeating steps (a)-(f), for each entailment generated, treating the new entailment as input data in the performance of the steps; (h) storing or having stored, by the one or more computers, in the historical user data datastore as historical user data of the user, the input data and all new entailments; (i) obtaining, by the one or more computers, via the one or more communication networks, output data comprising one or more from the group of points of interest along a route, predictive routes, and inferred destinations, based at least in part on the input data, the new entailments, the subset of historical user data, and GPS data; and (j) sending or having sent, by the one or more computers, via the one or more communication networks, the output data to a display for user utilization.

### BRIEF DESCRIPTION OF THE DRAWINGS

The above and related objects, features, and advantages of the present invention, will be more fully understood by reference to the following detailed description of the exemplary embodiments of the present invention, when taken in conjunction with the following exemplary figures, wherein:

FIG. 1 is a conceptual diagram of the inference process.

FIG. 2 is a relational diagram showing the relationship among ontology, domain, and conceptualization.

FIG. 3 is a schematic diagram of embodiments of an overall system consistent with the present invention.

FIG. 4A is a schematic diagram of embodiments of an inference engine.

FIG. 4B is a schematic diagram of embodiments of an inference engine in a driving experience enhancement application.

FIG. 4C is a schematic diagram of embodiments of an inference engine in a network intrusion security application.

FIG. 4D is a schematic diagram of embodiments of an inference engine in a medical diagnosis application.

FIG. 4E is a schematic diagram of embodiments of an inference engine in a genetic pattern analysis application.

FIG. 4F is a schematic diagram of embodiments of an inference engine in an unmanned vehicle application.

FIG. 5A is a schematic block diagram of embodiments of a flowchart that may be used to implement one feature of the invention.

FIG. 5B is a continuation of the schematic block diagram of FIG. 5A.

FIG. 6A is a schematic block diagram of embodiments of a flow chart that may be used to implement another feature of the invention.

FIG. 6B is a continuation of the schematic block diagram of FIG. 6A.

FIG. 7 is a schematic block diagram of embodiments of a computer system that may be used to implement the invention.

### DETAILED DESCRIPTION OF THE EMBODIMENTS

### Definitions

“Ontology.” In computer science and information science, an ontology is a formal representation of a set of concepts within a domain and the relationships among those concepts. It is used to reason about the properties of that domain, and may be used to define the domain. See, for example, Matthew Horridge and Peter F. Patel-Schneider, OWL 2 Web Ontology Language Manchester Syntax, April 2009. 6-21; Lee W. Lacy, OWL: Representing Information Using the Web Ontology Language, Victoria, BC: Trafford, 2005, 19-133; Risto Gligorov, Zharko Aleksovski, Warner ten Kate, Frank van Harmelen, “Using Google Distance to weight approximate ontology matches,” ACM WWW 2007; G. Stumme and A. Madche, FCA-Merge: Bottom-up merging of ontologies. In 7th Intl. Conf. on Artificial Intelligence (IJCAI '01), pages 225-230. Seattle, Wash., 2001.

“Semantic Web.” The Semantic Web is a web of data accessible via the cloud in which software agents, mechanisms to read and write semantic data, can process web content and make better use of the information on the web. It operates by using a set of pluggable (i.e., dynamic) ontologies that define domains and uses inferences to solve problems. Data on the World Wide Web is formatted using a semantic language that results in easier processing of data by providing a uniform format. It is enabled by a set of technologies that make it easier to share, connect, and discover information. Currently, the World Wide Web is a web of documents, intended for human consumption. The Semantic Web envisions a web of data, in which software agents (as well as people) can process web content and make better use of the information on the web.

“Open Jena.” Apache Open Jena is a semantic web processor and in-memory inference engine. It is an open source tool used for processing OWL and processing of inference rules in memory and creation of entailments. Open Jena is configured to allow for inference in memory only. This is a limitation since it cannot access storage. Open Jena is the de facto API for the entire Semantic Web Community. Nearing release 3.0, Open Jena, now in existence since the late 1990's, is a mature functioning product specifically used in production systems.

“SOLR.” Apache Solr is an engine that stores data in a significantly indexed way across a large heterogeneous cluster with indexes created on every item stored. Solr is not dependent on the underlying hardware or operating system. Solr provides fault tolerance in such a way that processing continues through failures, until it is down no nodes. Solr is completely fault tolerant and load balanced. Solr is integrated into many commercial projects including JBoss, Websphere, WebLogic and dozens of other tools.

“Node.” Nodes are Solr processors that attached together through a clustering environment. Data replication and segmentation occurs at the definition level such that concurrent reads and writes occur without increased overhead. In embodiments, the node software is cluster unaware with the infrastructure handling the difference in node numbers.

“Smart JSON.” JavaScript Object Notation (JSON) is a lightweight interchange format initially associated with Java Script and Asynchronous Java Script. It is now a standard of interoperability providing for extensibility without a rewrite of interface software. JSON here is referred to as Smart JSON because it contains data added or re-ordered through an inference engine.

“RDF.” Resource Description Framework (RDF) is a semantic language that predates OWL. The early web was designed around HTML to display text and images in browsers, with the ability to link between pages. Unfortunately, computers cannot use this HTML information in an automated way or perform complex tasks with it. HTML renders content in a browser, but it was not designed to support processing against the data embodied within that content. The World Wide Web Consortium worked to fix this problem by developing and deploying Semantic Web technologies. RDF is a semantic language that provides implementation and formatting of data of the Semantic Web.

“OWL.” OWL is the Web Ontology Language. It is a W3C specification for terms and instances as related to domains. OWL is a refinement of RDF and more strongly typed than RDF. In embodiments, OWL's strong typing may be used to efficiently create entailments.

“TBox.” A TBox or term box comprises definitions, key words, and relationships. It is an unambiguously defined ontology of a domain.

“ABox.” An ABox or assertion box contains instances of TBox terms using input data and historical data.

“Entailment.” An entailment is a result of an inference, created by the automatic firing of rules and use of TBox, input data, and historical data.

“Domain.” A domain is an area of interest described by an ontology. In embodiments, the domains may be any vertical domain such as automotive, unmanned vehicles, calendars, social networks.

“Inference rule.” An inference rule is a logical form consisting of a function which takes premises or antecedents, analyzes their syntax, and returns a conclusion.

“Segment service.” A service which provides a “route segment” upon receiving GPS data.

“Route segment.” A route segment is a representation of a portion of a route, comprising a GPS start point and a GPS end point.

“REST.” Representational state transfer (REST) is a software architectural style that ignores the details of component implemental and protocol syntax in order to focus on the roles of components, the constraints upon their interaction with other components, and their interpretation of data elements. As a protocol for web services, it defines rules transmission of data across the web.

“Semantic. Store.” A semantic store is a type of datastore for storing entailments. In embodiments, the semantic store may be implemented on node clusters, and accessed by Solr.

Applicant has recognized that current inference engines generate all possible entailments and then match relevant entailments to input data. This process means that current inference engines cannot generate inferences without loading all definitions, all inference rules, and all historical data into memory. This process is limited by the amount of data which may be referenced, requires significant time for all inferences to finish generating, and requires loading definitions, rules, and data which may not be relevant to a particular input data. Additionally, any entailments generated are not persisted by current inference engines.

Embodiments of the claimed invention circumvent the need for loading all definitions, all inference rules, and all historical data. In embodiments, the invention loads precisely those definitions, inference rules, and historical data that are needed for the generation of entailments relevant to input data. This means rather than taking the “read” approach of current inference engines, where entailments are generated at read time and not stored, embodiments of the invention takes a “write” approach, where entailments are generated at write time and subsequently stored. In embodiments, the invention places the exact correct amount of ABox data from disk into memory to allow proper inferencing.

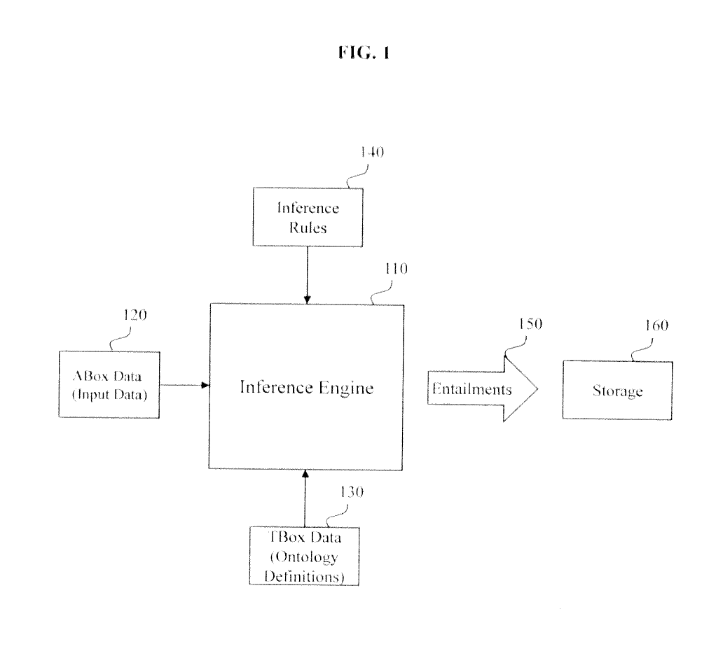

Referring to FIG. 1, a conceptual diagram of the invention process is disclosed. Inference engine 110 applies inference rules 140 to ABox data 120 formatted and specified by TBox data 130. The results of the inferences are Entailments 150, which are stored in Storage 160 for future use.

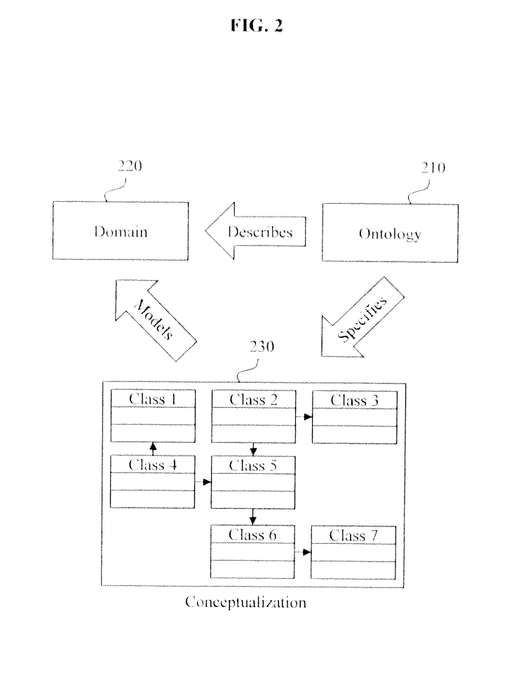

Referring to FIG. 2, a relational diagram shows the relationship among Ontology 210, Domain 220, and Conceptualization 230. Ontology 210 includes the definitions, key words, and relationships of a particular area of interest called a Domain 220. For instance, if Domain 220 is “Human Resources,” Ontology 210 could include, among others, the definitions of “person” and “organization of persons,” “addresses for persons,” and other terms with direct or indirect relationships to persons. Ontology 210 describes in unambiguous terms the various aspects of a Domain 220. Conceptualization 230 is a model of a Domain 220. For a Domain 220 of “Human Resources,” Conceptualization 230 implements the concepts of Domain 220 using, for instance, Java Class Objects. The Conceptualization 230 in turn is specified by Ontology 210. The Conceptualization 230 provides an implementation of the concept of “person” based on definitions from Ontology 210. Thus, conceptualization is a semantic structure that encodes implicit knowledge constraining the structure of a piece of a domain. Ontology is a (partial) specification of this structure, e.g., it is usually a logical theory that expresses the conceptualization explicitly in some language.

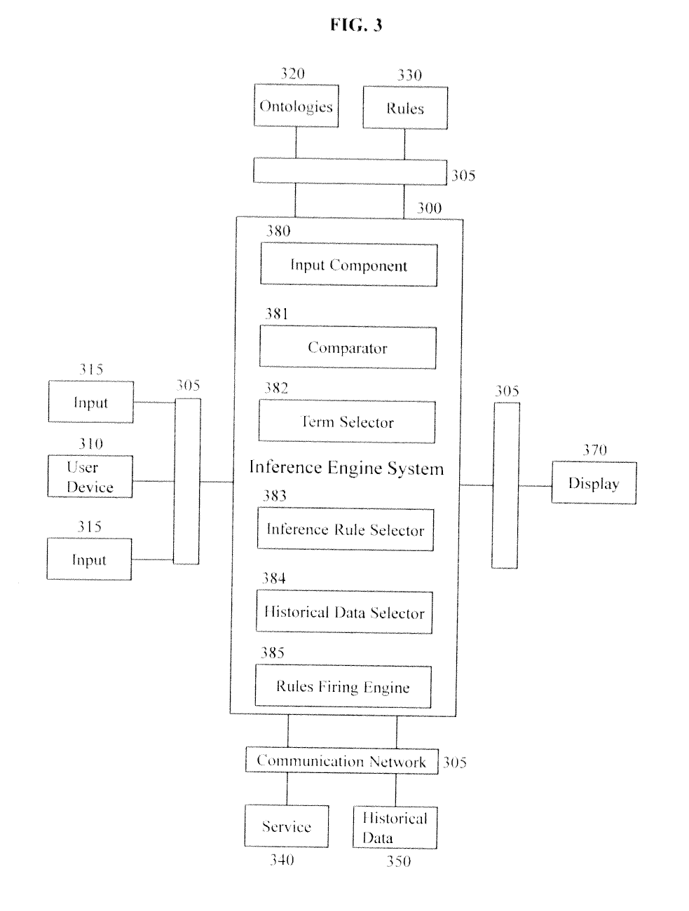

Referring to FIG. 3, embodiments of an overall configuration consistent with the invention are disclosed. In embodiments, an inference engine system 300 configured in one or more computers may receive input data via one or more communication networks 305 from various input nodes 315 and user device 310. In embodiments, input data may Abox or RESTFul data. RESTFul means a form of Web Services. In embodiments, input data may be any form of ABox given to the system through web services. This data may create entailments through rules, TBox and historical data. These terms are discussed below and in the definitions section. In embodiments, the domains may be any vertical domain such as automotive, unmanned vehicles, calendars, social networks.

In embodiments, the overall configuration may comprise a communication module 305 to connect the inference engine system 300 to one or more networks, such as the Internet.

In embodiments, the overall configuration may comprise a user device 310. In embodiments, the user device may be, e.g., a personal computer, a smartphone, a computer in a car, to name a few.

In embodiments, the inference engine system 300 may comprise or have access to various input nodes 315 for providing input data. The input data will vary depending on the application to which the inference engine is applied. For example, for embodiments dealing with automobiles, the input data may comprise one or more of GPS data, calendar data, Facebook data and/or other social network data, user preferences, and search queries, to name a few. For embodiments dealing with network access, the input data may comprise in embodiments, one or more of safety data, access attempt data, and preferences data. For embodiments dealing with medical issues, the input data may comprise in embodiments, one or more of blood pressure data, pulse rate data, and preferences data. For embodiments dealing with genetics, the input data may comprise in embodiments, one or more of genetic pattern data and genetic definition data. For embodiments dealing with unmanned vehicles, the input data may comprise GPS data, altitude data, and preferences data.

In embodiments, the inference engine system 300 may comprise an input component 380, a comparator 381, a term selector 382, a historical data selector 384, an inference rule selector 383, and a rules firing engine 385.

In embodiments, the rules firing engine 385 may be implemented by a reasoner engine capable of processing rules to create entailments. In embodiments, the rules firing engine 385 may be implemented using Apache Open Jena semantic web processor.

In embodiments, the inference engine system 300 may comprise an input component 380, which is configured to obtain the input data from the input nodes 315.

The input data may be pushed or pulled to inference engine 300. Input data may be pushed or pulled at regular or any interval of time. In embodiments, the input data may be in Web Ontology Language (OWL). OWL allows for different languages to be semantically compatible with the disparate architecture of the World Wide Web.

In embodiments, the inference engine system 300 may comprise or have access to an ontologies datastore 320 for storing various ontologies. The ontologies datastore 320 stores a multitude of domain ontologies, where an ontology is a formal representation of a set of concepts within a domain and the relationships between those concepts. It is used to reason about the properties of that domain, and may be used to define the domain.

In embodiments, the inference engine system 300 may comprise a comparator 381, configured to compare the input data to the ontologies in ontologies datastore 320.

In embodiments, the inference engine system 300 may comprise a term selector 382, which is configured to determine a set of selected terms from the multitude of ontologies, based at least in part on results from the comparator 381 comparing the input data to the ontologies in ontologies datastore 320.

In embodiments, the inference engine system 300 may comprise or have access to a rules resource 330. In embodiments, the rules resource 300 may be accessible from the Internet. The rules resource 330 provides a multitude of inference rules, where an inference rule is triggered by one or more premises or antecedents, and results in a conclusion. The conclusion is an entailment.

In embodiments, the inference engine system 300 may comprise an inference rule selector 383, which is configured to select a plurality of the inference rules from the rules resource 330 based at least in part on the selected terms and the input data.

In embodiments, the inference engine system 300 may comprise or have access to a service 340, which may be an external service, for providing further input data. For embodiments relating to the automobile, the service may provide route segment data. For embodiments relating to the network, the service may provide failed attempt access data. For embodiments relating to the medical, the service may provide predictive medical analysis data. For embodiments relating to genetics, the service may provide pattern mapping data. For embodiments relating to the unmanned vehicle, the service may provide route segment data.

In embodiments, the inference engine system 300 may comprise or have access to a historical data datastore 350. The historical data will vary depending on the application. For embodiments relating to the automobile, the historical data may comprise past user likes, past calendar events, previous routes taken, and all generated entailments. For embodiments relating to the network, the historical data may comprise past access attempts and past failed attempts and provenance of past failed attempts. For embodiments relating to the medical, the historical data may comprise past blood pressure, past pulse rate, and past heart health. For embodiments relating to the genetic, the historical data may comprise past patterns and past genetic definitions. For embodiments relating to the unmanned vehicle, the historical data may comprise previous routes. In embodiments, historical data datastore 350 may be implemented on a node cluster processed using Apache Solr. In other embodiments, historical data datastore 350 may be implemented using HBASE or a relational database. Note that currently Solr is not aware of Machine Learning or OWL, just as Open Jena is unaware of clustered storage and memory management. Solr has no understanding of machine learning, and Open Jena has no understanding of persistence. Embodiments of the invention merge these two concepts. In embodiments, these two technologies may be attached or configured together, providing multi-terabyte inferencing. In embodiments, the invention comprises an algorithm and design that provides fault tolerance, load bearing, and load balancing.

In embodiments, the inference engine system 300 may comprise a historical data selector 384, which is configured to select, based at least in part on the selected terms and the plurality of inference rules, from a historical data datastore 350, a subset of historical data.

Based at least in part on the input data from the nodes 315 and device 310, the inference engine system 300 may obtain domain ontologies (term sets) from ontologies datastore 320 and inference rules from rules resource 330 via the communications modules 305. The inference engine system 300 may obtain additional input data from service 340. The inference engine system 300 may receive historical data from the historical data datastore 350.

In embodiments, the inference engine system 300 may relate to generating or obtaining automobile data. For example, the inference engine system 300 may send GPS data received as input data to a segment service 340 via the one or more communication networks, and receive back one or more route segments. In embodiments, the inference engine system 300 may create route segments dynamically. In embodiments, segment service 340 may be located on the Internet. In embodiments, the segment service 340 may be accessed using web services.

Output data may be obtained by the inference engine system 300 and displayed on a display 370 for user utilization. In embodiments, the display 370 may be, e.g., a personal computer, a smartphone, a computer in a car, to name a few.

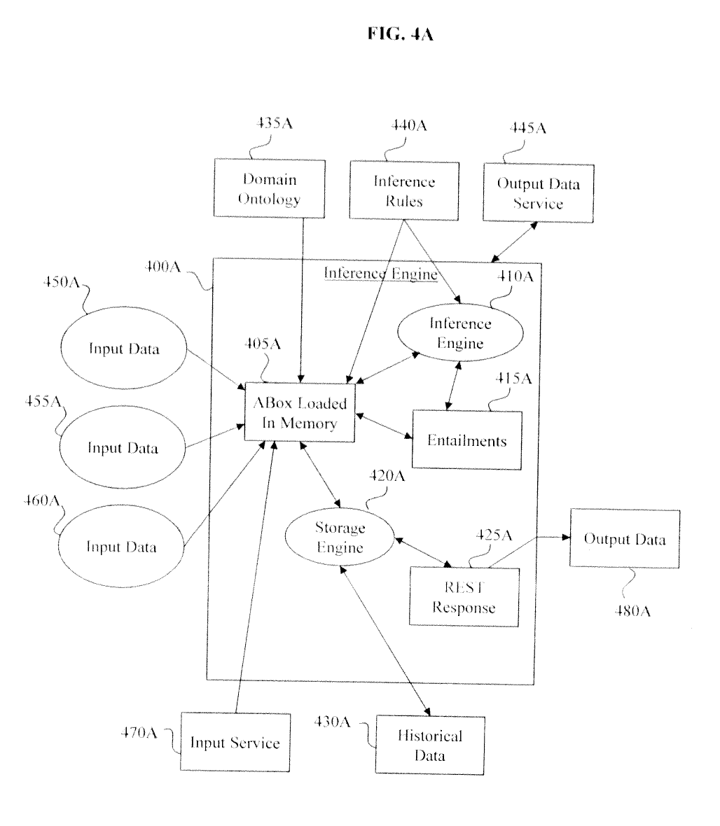

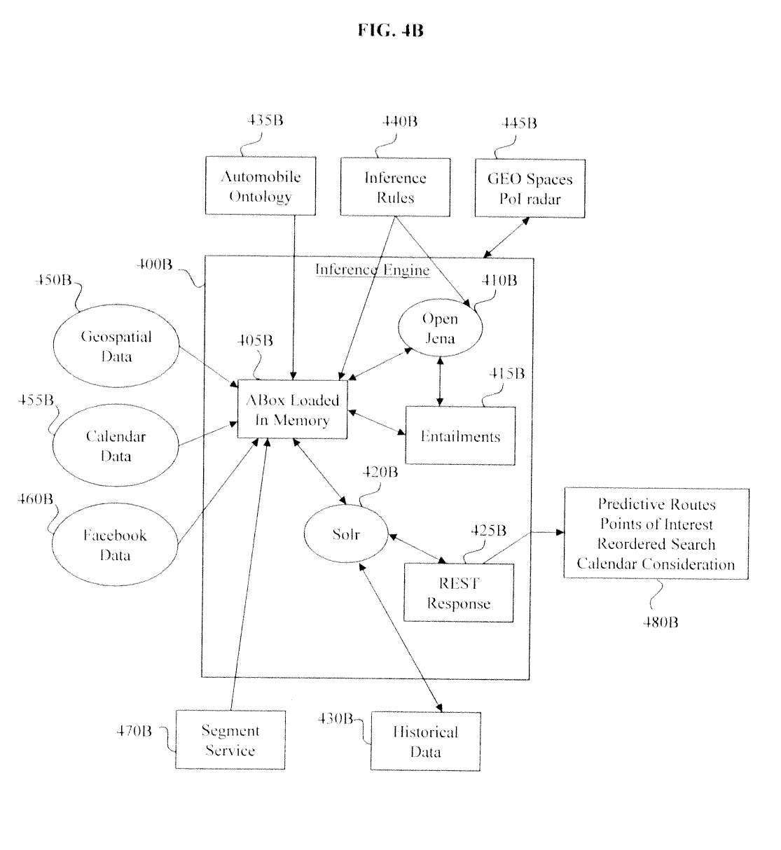

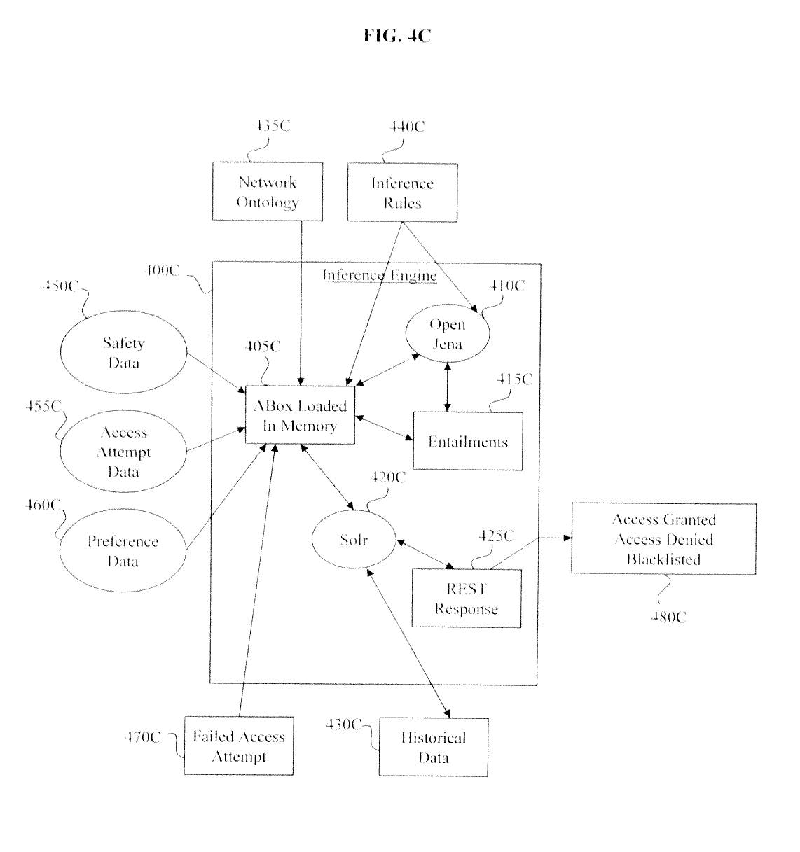

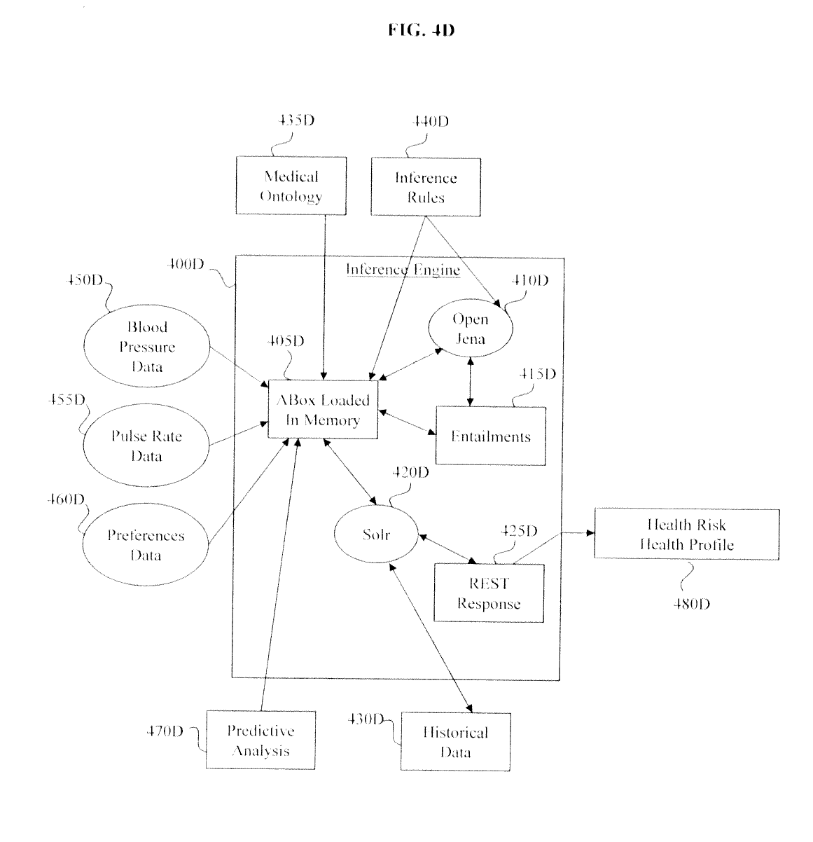

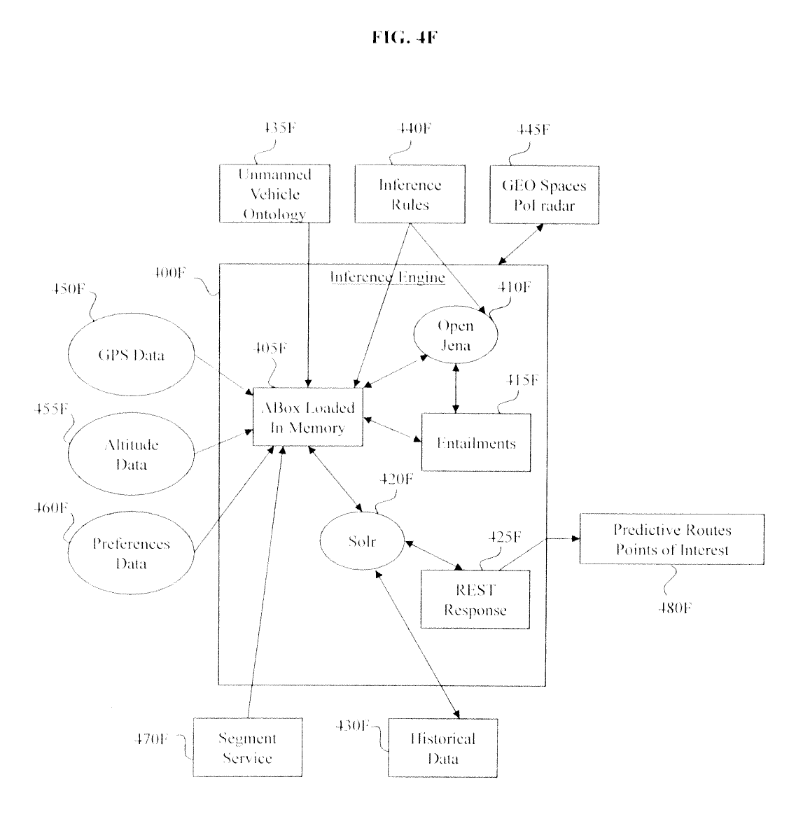

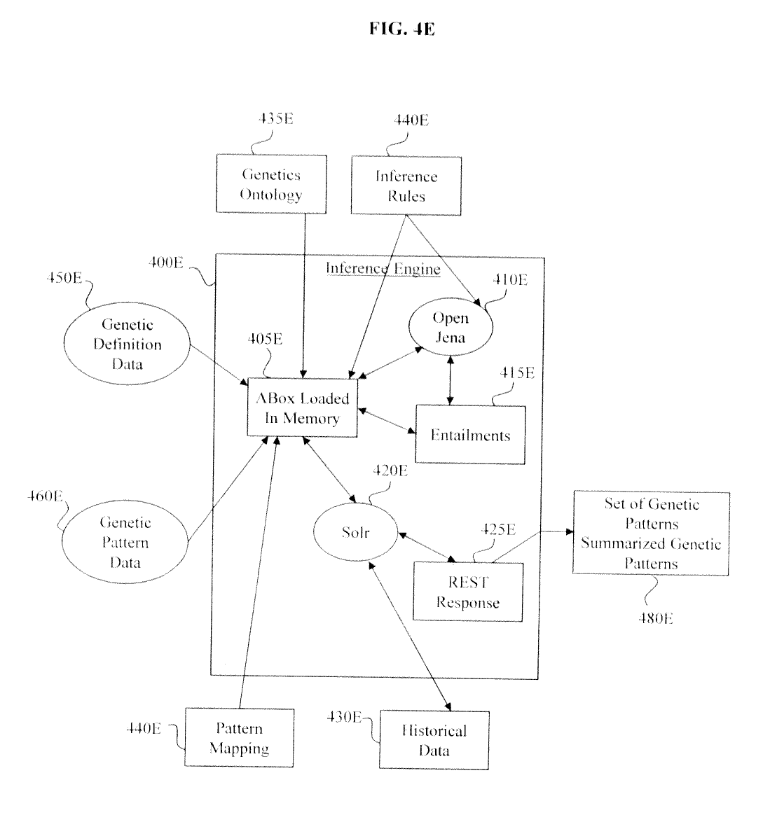

FIG. 4A illustrates a generic system for implementing embodiments of the invention. This generic system may be used in a variety of different fields, such as automotive (FIG. 4B), computer network (FIG. 4C), medical (FIG. 4D), genetics (FIG. 4E), and unmanned vehicles (FIG. 4F), to name a few. In embodiments, such a generic system may comprise input data 450A-460A, domain ontology datastore 435A, inference rules resource 440A, historical data datastore 430A, storage engine 420A, and inference engine 410A. Input data need not necessarily be limited to three types or from three sources.

Referring to FIG. 4A, embodiments of the inference engine are disclosed. Inference engine 400A is configured to process the input data from data sources 450A-460A against a dynamic set of ontologies from ontology datastore 435A and inference rules from a resource 440A. New entailments 415A may be continuously created by the inference engine 410A as data is analyzed and stored for future use.

In embodiments, the inference engine 410A may be implemented using a reasoner engine for firing inference rules to generate entailments. In embodiments, the inference engine may be implemented using Open Jena, a semantic web processor and in-memory inference engine. Open Jena allows for inference in memory.

In embodiments, a historical data datastore 430A may store all historical data obtained or generated by the system, and includes historical input data as well as generated entailments. In embodiments, the data stored in the datastore 430A, whether input data or generated entailments, may be tagged with provenance which indicates the probability of accuracy of the data, who stored the data, when the data was stored, the original source of the data, and how the data was obtained.

In embodiments, the historical data datastore 430A may be implemented as a cluster of nodes processed using a storage engine 420A. In embodiments, the storage engine 420A may be implemented using Apache Solr, for indexing each piece of data for faster future access.

The input data from data sources 450A-460A, historical data from historical data datastore 430A, domain ontologies from ontology datastore 435A, inference rules from rules resource 440A, and input data from an input service 470A may be formatted and loaded as ABox data in ABox 405A. ABox 405A represents instances of TBox (e.g., instances of “person” and “organization,” for the domain of Human Resources) in memory, inference rules, historical data, and any input source data.

Entailments, represented as block 415A, are generated by the inference engine 400A, and may be based on one or more selected from the group of input data from input data 450A-460A, input data obtained from input service 470A, ontologies from datastore 435A, rules from resource 440A, and historical user data from historical data datastore 430A. In embodiments, Entailments 415A may be used as ABox data for generating subsequent entailments.

Entailments from the entailments block 415A may be sent, along with input data, historical data, and input data from input service 470A to an output data service 445A to produce output data 480A. In embodiments, the output data 480A is formatted with proper protocols via the REST transfer block 425A. In embodiments, the output data 480A may be formatted for SOAP.

Referring to FIG. 4B, a schematic diagram of embodiments of the system in a driving experience enhancement application is disclosed. In embodiments, input data may comprise GPS data 450B, calendar event data 455B, and Facebook Like data 460B. In embodiments, the input service may comprise a segment service 470B for providing road segments based on GPS points. In embodiments, the segment service 470B may provide route segment data, that may then be included in Abox 405B.

In embodiments, the historical data datastore 430B may comprise historical data such as past calendar events, previous routes taken by a user, user's likes, etc.

In embodiments, an output data block 480B may comprise inferred destinations, reordered search results, and nearby points of interest from a GEO Spaces PoI radar 445B. In embodiments, the inferred destinations may take into consideration historical, current, and impending location data. In embodiments, reordered search results may place selected links at the top of the results list.

Referring to FIG. 4C, a schematic diagram of embodiments of the system in a network intrusion security application is disclosed. In embodiments, the input data may comprise safety data 450C, access attempt data 455C, and preference data 460C. In embodiments, failed access attempt data from a failed access attempt service 470C may be included in Abox 405C. In embodiments, the failed access attempt service 470C may provide failed access attempt data based on access attempt data 450C.

In embodiments, the historical data from historical data datastore 430C may comprise past access attempts and past failed attempts and provenance thereof. In embodiments, the output data from an output data block 480C may comprise whether a machine is blacklisted and whether access is granted or denied.

Referring to FIG. 4D, a schematic diagram of embodiments of the system in a medical diagnosis application is disclosed. In embodiments, input data may comprise blood pressure data 450D, pulse rate data 455D, and preferences data 460D. In embodiments, predictive medical analysis data from a predictive service 470D may be included in Abox 405D.

In embodiments, historical data from historical data datastore 430D may comprise past blood pressure, past pulse rate, etc. In embodiments, output data 480D may comprise health risk and health profile.

Referring to FIG. 4E, a schematic diagram of embodiments of the system in a genetic pattern analysis application is disclosed. In embodiments, input data may comprise genetic definition data 450E and genetic pattern data 460E. In embodiments, genetic pattern data from a pattern mapping service 470E may be included in Abox 405E. In embodiments, the pattern mapping service 470E may provide genetic patterns based on genetic data 450E.

In embodiments, historical data from historical data datastore 430E may comprise past genetic definitions and past genetic patterns. In embodiments, output data 480E may include set of genetic pattern, summarized genetic patterns, etc.

Referring to FIG. 4F, a schematic diagram of embodiments of the system in or for use with an unmanned vehicle application is disclosed. In embodiments, the input data may comprise GPS data 450F, altitude data 455F, and preferences data 460F. In embodiments, route segment data from a segment service 470F may be included in Abox 405F. In embodiments, the segment service 470F may provide route segments based on GPS data 450F.

In embodiments, historical data from historical data datastore 430F may comprise previous routes. In embodiments, output data 480F may include set of points of interest along a route, predictive routes, etc.

Definitions, key words, and relationships, in embodiments, from the ontology blocks 435 may comprise a box of terms referred to as a term box or TBox. Instances of these terms are instantiated as assertions in ABox, where assertions are statements of fact or statements that are true.

In embodiments, the inference engine system defines the problem space, e.g., TBox, using the fact instances and entailments developed using inference rules. Instances of TBox concepts using input data is sent as ABox to the inference engine. The inference engine system takes the inference rules, TBox definitions (domain ontology), historical data, and ABox input data and fires appropriate rules triggered by the ABox data to create further entailments for subsequent reads. This process eventually produces entailments that are stored using Solr and/or may be sent to a service to provide output data to a display for user utilization.

The following are the contents of exemplary TBox files:

public class AutoIE {
/** <p>The ontology model that holds the vocabulary terms</p> */
private static OntModel m_model = ModelFactory.createOntologyModel(
OntModelSpec.OWL_MEM, null );
/** <p>The namespace of the vocabulary as a string</p> */
public static final String NS = “http://www.compscii.com/ontologies/0.1/AutoIE.owl#”;
/** <p>The namespace of the vocabulary as a string</p>
* @see #NS */
public static String getURI( ) {return NS;}
/** <p>The namespace of the vocabulary as a resource</p> */
public static final Resource NAMESPACE = m_model.createResource( NS );
public static final ObjectProperty DestinationHasAsAnEvent =
m_model.createObjectProperty(
“http://www.compscii.com/ontologies/0.1/AutoIE.owl#DestinationHasAsAnEvent” );
public static final ObjectProperty describesLikesAs = m_model.createObjectProperty(
“http://www.compscii.com/ontologies/0.1/AutoIE.owl#describesLikesAs” );
public static final ObjectProperty driverDrivesARoute = m_model.createObjectProperty(
“http://www.compscii.com/ontologies/0.1/AutoIE.owl#driverDrivesARoute” );

The above code illustrates factual statements and further factual statements, e.g., entailments represented as Java types.

Now looking at the use of the generated files in the creation of ABox, the task below is designated as aboxpersona and it is used to create the ABox entries describing all users, with their associated interests:

```
<target name=“aboxpersona”
description=“create ABox for User Preferences”
depends=“compileAbox”>
    <copy todir=“${classes.dir}” file=“logging.properties”/>
    <copy todir=“${classes.dir}” file=“load.properties”/>
    <java classname=“feast.util.abox.LoadPersonas”
    output=“${classes.dir}/abox.persona.log”>
        <sysproperty key=“java.util.logging.config.file”
        value=“${basedir}/logging.properties”/>
        <classpath>
        <path refid=“classpath.tools” />
        </classpath>
        <arg value=“result” />
        <arg value=“/result01” />
    </java>
</target>
```

An example of the use of this file in creating a person “John” and assigning him to a group appears below:

```
public static void addPerson(InfModel model) {
    Individual provenance = Provenance.Provenance
        .createIndividual(Provenance.getURI( )
            + System.currentTimeMillis( ));
    model.add(provenance, Provenance.who, “Facebook Likes”);
    model.add(provenance, Provenance.when,
        DatatypeConverter.printDateTime(new GregorianCalendar( )));
    model.add(provenance, Provenance.sourceDocument,
        “http:www.facebook.com/”);
    model.add(provenance, Provenance.probability, “1”);
    Individual provenanceJohn = Provenance.Provenance
        .createIndividual(Provenance.getURI( )
            + System.currentTimeMillis( ));
    model.add(provenanceJohn, Provenance.who, “Test”);
    model.add(provenanceJohn, Provenance.when,
        DatatypeConverter.printDateTime(new GregorianCalendar( )));
    model.add(provenanceJohn, Provenance.sourceDocument,
        “http:www.johndoe.com”);
    model.add(provenanceJohn, Provenance.probability, “1”);
    Individual john = createBusinessCard(model, “John Doe”,
        “(111) 222-3333”,
        “john@johndoe.com”, “VIPCommunity”,
        “1/1/1970”, provenanceJohn);
    Individual techie = createGroup(model, “Techie”, provenance);
    addPersonToGroup(model, john, techie, provenanceJohn);
}
```

This code uses TBox (domain ontology) and input data of a user to create ABox resulting in the automatic creation of further entailments. It adds John to the Group “Techie” and then adds the interests of that group to John.

The ABox is generated from the LoadPersonas.java file. To add a provenance record, an Individual is created using the properties Provenance.[x]. The Subject is provenanceJohn which is the subject of the statement that the John Provenance, has a provenance record named “when.” Additional provenance record includes probability of accuracy of the record, who stored the record, original source of the record, and how the record was obtained.

To actually load the personas to the Semantic Store the following task below occurs:

```
<target name=“loadpersona”
    description=“load the data through a web service”
    depends=“compileutil”>
    <mkdir dir=“${classes.dir}”/>
    <copy toFile=“${classes.dir}/load.properties” overwrite=“true”
    file=“load.properties”/>
    <java classname=“feast.util.LoadAboxWebService” fork=“true”
    output=“${classes.dir}/webservice.persona.log”>
        <classpath>
            <path refid=“war.classpath”/>
        </classpath>
        <arg value=“data/auto/result01.nt” />
    </java>
    <antcall target=“runoptimize”/>
</target>
```

The preceding task uses a web services program to load the personas. LoadAboxWebService is the program for loading all ABox data. The input file is specified as an input argument parameter. The <arg value=“data/auto/result01.nt” I> specifies the result01.nt (from aboxpersona task) is now input to the semantic store. The difference on behavior based on the ABox comes from the rule base. The rules specify downstream processing. The downstream processing looks at data in memory and fires rules to create new data. This processing creates entailments in memory, which are stored, with originating data, in the semantic store, which is a type of datastore.

The very simple example of an entailment is the creation of a numeric ontology with a transitive property for “greater than.” We state in RDF/XML that 100 is greater than 10 and 10 is greater than 1. The RDF/XML appears below.

The terms and definitions in TBox are:

<rdf:RDF
xmlns:rdf=“http://www.w3.org/1999/02/22rdfsyntaxns#”
xmlns:j.0=“http://domains.com/numeric#”
xmlns:owl=“http://www.w3.org/2002/07/owl#”
xmlns:xsd=“http://www.w3.org/2001/XMLSchema#”
xmlns:rdfs=“http://www.w3.org/2000/01/rdfschema#”
xmlns:bool=“http://domains.com/boolean#” >
<rdf:Description rdf:about=“http://domains.com/numeric#Value”>
<rdf:type rdf:resource=“http://www.w3.org/2002/07/owl#Class”/>
</rdf:Description>
<rdf:Description rdf:about=“http://domains.com/boolean#greaterThan”>
<rdf:type rdf:resource=“http://www.w3.org/2002/07/
owl#TransitiveProperty”/>
</rdf:Description>

This provides a class called value that describes numbers, and a relation called “greater than” that behaves in a transitive manner.

Now with the ABox, assertions are made based on the terms and definitions and other items in TBox.

<rdf:Description rdf:about=“http://value/1”>
<rdf:type rdf:resource=“http://domains.com/numeric#Value”/>
</rdf:Description>
<rdf:Description rdf:about=“http://value/10”>
<rdf:type rdf:resource=“http://domains.com/numeric#Value”/>
</rdf:Description>
<rdf:Description rdf:about=“http://value/100”>
<rdf:type rdf:resource=“http://domains.com/numeric#Value”/>
</rdf:Description>
<rdf:Description rdf:about=“http://value/10”>
<bool:greaterThan rdf:resource=“http://value/1”/>
</rdf:Description>
<rdf:Description rdf:about=“http://value/100”>
<bool:greaterThan rdf:resource=“http://value/10”/>
</rdf:Description>

The creation of the entailment in this instance via an inference rule using the transitive property is as follows: The transitive property for “greater than” shows 100 is also greater than 1.

<rdf:Description rdf:about=“http://value/100”>
<bool:greaterThan rdf:resource=“http://value/1”/>
</rdf:Description>
</rdf:RDF>

Data input functions have a dependence on a rules base. In embodiments, all or substantially all input is treated as ubiquitous ABox, e.g., embodiments may work for any input or domain. The only things that differ are the processing rules. The processing rules always create additional data and/or remove data. Thus, there will be faster and better processing after the rules fire. In embodiments, for the current state of rule processing, it is performed in memory only. Thus, the rules and the data in the TBox are reviewed to decide exactly which rule premises or antecedents are needed in memory, such that the rules may properly fire. For example, the input data is a Facebook Like, and the rules for Like fire to add an additional interest area to the user. If enough interest areas have been added to a user, the user may qualify to be added to a group, and the group's interest areas may in turn be added to the user, which may result in additional entailments and additional interest areas being added to the user. However, if not enough data from the semantic store (the one or more datastores for the historical data and the input data) is loaded into memory, then at rule firing time, a given rule will not have its premises or antecedents satisfied, and entailments are not generated. Since entailments are critical to analytics, the proper amount of data, must load into memory, before the rules fire. This is accomplished via the TBox and ABox processing. In embodiments, significant effort may occur inside the software to ensure the proper formation of entailments via the rule base and the loading of the necessary antecedents from the semantic store.

An example rule and what must occur for the rule to work properly is discussed. The example rule adds a group's interests to an individual:

[IndividualGetsGroupInterests: (?x ie:memberOf ?y),
(?y ie:hasGroupInterestOf ?z) > (?x ie:hasIndividualInterestOf ?z)]

Jena documentation states, “A rule for the rulebased reasoner is defined by a Java Rule object with a list of body terms (e.g., premises or antecedents), a list of head terms (conclusions) and an optional name and optional direction.” Examination of the Jena Rule syntax indicates that the name of the rule is IndividualGetsGroupinterests. The premises are (?x ie:memberOf ?y) and (?y ie:hasGroupinterestOf ?z). The two premises are separated by a comma, which indicates an implied “AND.” The ?x stands for “example person”. ie:memberOf state means that the example person is a member of a group, denoted by ?y. The next premise indicates that the group, previously defined as ?y has a group interest of ?z as denoted by ?y ie:hasGroupinterestOf ?z. Putting this together, if an arbitrary person is a member of a group (the premise or antecedent) and the group has interest areas then [something is true], e.g., the entailment. Thus, this is a set of premises that may evaluate to true. The direction of > indicates to create the entailment person has an individual interest of the ?z. This is a transitive rule that says if a person is member of a group and the group has interests, the person now inherits those interests. The ?x ie:haslndividualInterestOf ?z creates one to many data in memory that get written by Solr as entailments.

Another example rule is:

[CalLocToDest: noValue(?p ie:eventHasAsADestination ?t),
(?p ie:eventHasAsALocation ?l) >
CalLocDest(?p ie:eventHasAsADestination ?t)]

This rule is referred to as a Calendar Location to Destination rule. It operates as follows. If there is not an actual destination location as given by a latitude and longitude, then the systems retrieves the definition of a location, which will be an address, and adds entries that make up a proper latitude and longitude from the address. The entailment is the Destination as a TrackPoint.

Another example rule is:

[CalTextToDest: noValue(?p ie:eventHasAsALocation ?l), noValue(?p
ie:eventHasAsADestination ?t), (?p ie:eventCommittedByPerson ?y),
(?p ie:eventDescription ?l) > CalTextDest(?p
ie:eventHasAsADestination ?t)]

According to the rule above, if a calendar event does not have a Destination or a Location then the text of a calendar event is examined and to obtain a destination. For example, if the text is Drugstore or Pharmacy, the system looks for the closest match for drugstores or pharmacies and fills in the Destination Trackpoint with that closest match, e.g., the entailment.

Another example rule is:

[PointToSegment: (?r ie:isTrackedBy ?p), (?p Vcard:latitude ?s),
(?p Vcard:longitude ?m), (?p ie:trackPointWhen ?t), (?p ie:pointStatus
“point”) > PointToSegment(?r ie:hasLineSegment ?l)]

In some embodiments, this may be a significant rule. The rule takes individual track points and creates route segments, thereby reducing the algorithms from a point oriented (slow) algorithm, internal to the Inference Engine system, to a fast algorithm that works via segments. The input and output of the system are still points, but all internal storage is segments. Matching may be done via segments, and results may be given as points on segments, with new segments only formed when the road changes.

Another example rule is:

[PersonLike: (?p ie:describesLikesAs ?o), (?o ie:opinionCategory ?y) >
Like(?p ie:hasIndividualInterestOf ?z)]

This rule is named PersonLike. As with other rules, it creates entailments. It starts with the premises for Likes and Opinions: (?p ie:describesLikesAs ?o), (?o ie:opinionCategory ?y). If a person has a like opinion and the opinion has an opinion category, then fire a custom rule called Like. This Like rule creates individual interests, e.g. entailments for a person. Thus, the ABox creates entries for a person that has a like and the like has an opinion category. The opinionCategory rule is then fired by the Like.java to create more ABox entries or entailments in the context. The context moves to the in-memory representation of semantic data, which, as the next action, gets written to the semantic store. Here, context means a localized representation associated with a given session.

Subsequent rules may trigger based on the individual interests of the given user to add the user to a group. Additional rules fire to obtain the interest areas of the group that was just joined, and to add those group interests as interests of the user. The group interests automatically added for the user are entailments. Thus, the downstream processing looks at input in memory from ABox and fires rules to create new data for ABox. This processing creates entailments in memory, which are stored, with originating data, in the semantic store.

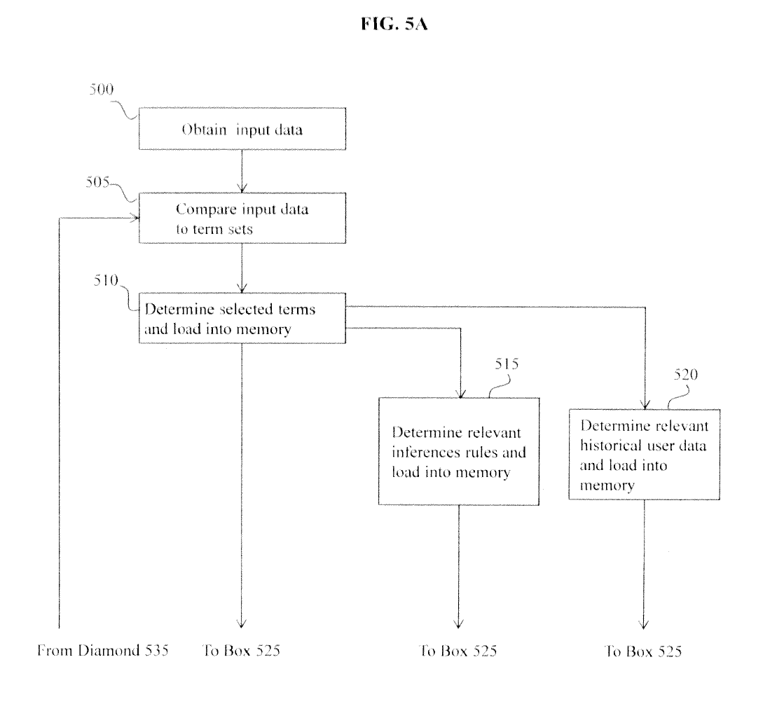

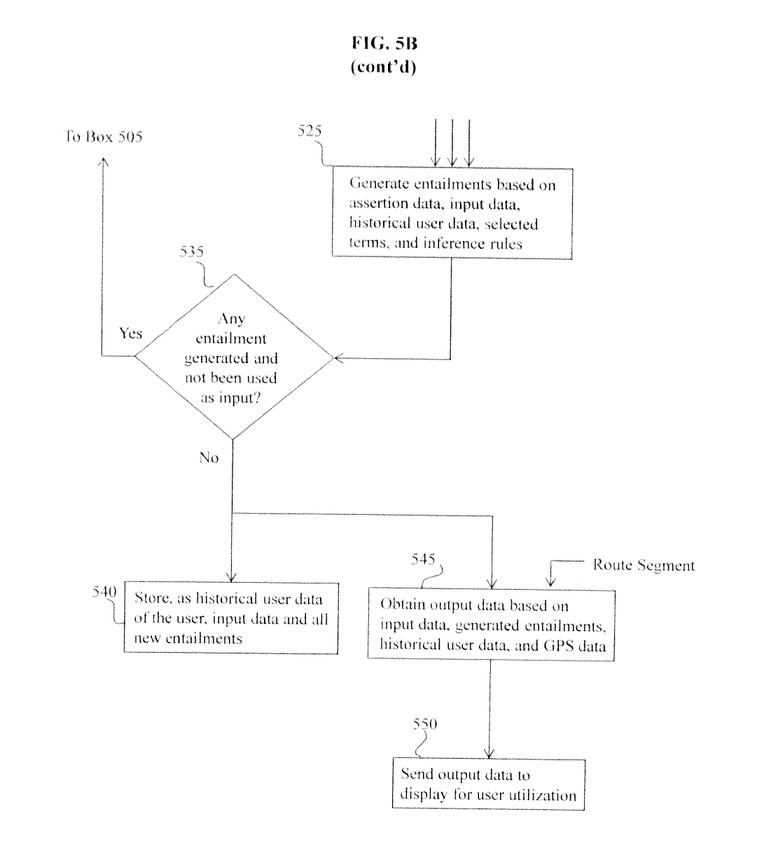

Referring to FIG. 5, embodiments of a process consistent with the invention are disclosed. Block 500 represents a computer operation of obtaining, by one or more computers, via one or more communication networks, input data of a user comprising one or more selected from the group of calendar events, GPS data, social network activity, search queries, and user preferences, where the input data may be semantically structured and/or non-semantically structured. For instance, a user may indicate liking guacamole. Input data may be obtained using an input component configured in the one or more computers. In embodiments, the input data comprises three or more selected from the group of calendar events, GPS data, social network activity, search queries, and user preferences. In embodiments, the input data comprises all from the group of calendar events, GPS data, social network activity, search queries, and user preferences.

Block 505 represents a computer operation of comparing, by the one or more computers, the input data to a group of term sets, where a term set comprises one or more selected from the group of key words, definitions, and relationships for an area of interest. For instance, term sets may include [Food], [Skiing], [Hemingway], while key words may include [Chips], definitions may include [Guacamole is an avocado-based dip], and relationships may include [Guacamole is used in Mexican cuisine]. These term sets may be selected based on a user Like in his/her social network activity data. This comparison may be done using a comparator configured in the one or more computers. In embodiments, the term set comprises key words, definitions, and relationships for an area of interest.

Block 510 represents a computer operation of determining, by the one or more computers, based at least in part on results of the comparing step, selected terms, where the selected terms comprise a plurality of key words and/or definitions and/or relationships from the group of term sets, and loading the selected terms into memory, which is non-persistent. For instance, terms selected may include [Chip], [Guacamole is an avocado-based dip], [guacamole is used in Mexican cuisine]. This determination may be done using a term selector configured in the one or more computers. In embodiments, the selected terms comprise key words, definitions, and relationships from the group of term sets.

Block 515 represents a computer operation of selecting, by the one or more computers, based at least in part on the selected terms and the input data, a plurality of inference rules from a rules resource, and loading the plurality of inference rules into the memory. For instance, inference rules may comprise [People who like guacamole like burritos], and [People who like burritos and tacos like Mexican food]. This selection may be done using an inference rule selector configured in the one or more computers.

Block 520 represents a computer operation of selecting from a historical user data datastore, by the one or more computers, based at least in part on the selected terms and the plurality of inference rules, a subset of historical user data comprising past input data of the user and previously generated entailments of the user, where an entailment is an automatically-machine-generated conclusion of an inference rule, and loading the subset of the historical user data into the memory. Historical user data is data already known about the user. For instance, this user may have past user data such as [User likes tacos]. This selection may be done using a historical data selector configured in the one or more computers. In embodiments, semantically structured input data may be instantiated, based at least in part on the selected terms and non-semantically-structured input data.

Block 525 represents a computer operation of generating by firing one or more of the inference rules, using a rules engine configured in the one or more computers, one or more new entailments based at least in part on the input data, the subset of historical user data, the selected terms, and the inference rules. For instance, the Like input data [User likes guacamole] matches the assertion or antecedent for the inference rule [People who like guacamole like burritos], which fires, resulting in the entailment [User likes burritos]. This generation may be done using a rules engine configured in the one or more computers.

Diamond 535 represents a computer operation, when a new entailment is generated, of triggering a repeating of the computer operations represented by Blocks 500-525, for each entailment generated, treating the new entailment as input data in the performance of the computer operations. The input data [User likes burritos] with the input data [User likes tacos] match assertions for the inference rule [People who like burritos and tacos like Mexican food], triggering this inference rule to fire, resulting in the entailment [User likes Mexican food].

Block 540 represents a computer operation of storing, by the one or more computers, in the historical user data datastore as historical user data of the user, the input data and all new entailments. In embodiments, the input data and all new entailments stored as historical user data of the user may be tagged with provenance.

Block 545 represents a computer operation obtaining, by the one or more computers, via the one or more communication networks, output data comprising one or more from the group of points of interest along a route, predictive routes, and inferred destinations, based at least in part on the input data, the new entailments, the subset of historical user data, and GPS data. For instance, the entailment [User likes Mexican food] together with GPS data could return nearby Mexican food establishments, or may provide this data during certain time windows. In embodiments, the output data further comprises one or more from the group of calendar event reminders and reordered search results, obtained by the one or more computers, based at least in part on the input data, the new entailments, the subset of historical user data, and the GPS data. In embodiments, the GPS data comprises route segment data, wherein a route segment comprises a GPS start point and a GPS end point.

Block 550 represents a computer operation of sending, by the one or more computers, via the one or more communication networks, the output data to a display for user utilization. For instance, the user may select one of the displayed nearby Mexican food establishments and a route to the establishment may be generated.

### Routes

In embodiments, an automotive implementation may be configured to operate on route segments. In this respect, a route has a name, an origin, a destination, a list of route segments, and a status. A route segment has a start GEOPoint, an end GEOPoint, and a “current GEOPoint.” The “current GEOPoint” is the actual GEOPoint in the initial data that fired the rule that generated the given route segment. A route segment also has a when and a status. A GEOPoint has a latitude, longitude, when, and a status. A route segment is also known as a line segment. These relationships are illustrated below in Boolean:

### ListTrackPoints

ListTrackPoints takes in the following parameters:
inference (true/false) (default true)
   Boolean on whether inference points are returned
history (true/false) (default true)
   Boolean on whether history points are returned
since (String in zulu time) (default 2013-01-01102:16:48.3830-05:00)
   points that are returned must have occurred after the time represented by since
auto (String of auto number) (default null)
   a unique identifier that represents an individual automobile in the data
id (unique identifier string) (default auto)
   identifies which route history summary to look up
   if id is null, it uses the auto parameter as the id
events (true/false) (default true)
   Boolean on whether events are returned
routeTime (true/false) (default true)
   Boolean on whether the time historical routes took place should be taken into consideration when inferring the route
listNearbyPOI (true/false) (default true)
   Boolean on whether points of interests are returned
actual (true/false) (default true)
   Boolean on whether actual points are returned
Route (string of route identifier) (default null)
   Route identifier, if set it brings back this route as the actual route
maxActualSegments (integer) (default max docs returnable by SOLR)
   Number of line segments on the actual route to be returned
reset (true/false) (default false)
   Boolean on whether the route history summary should be reset
   If false, it will keep the route history summary in memory—any removed routes will stay removed until this is called with reset true or the application is redeployed on the server

The following is a description of functions used in creating a current route.

### ListTrackPoints.Main( )

1. If reset is true, it resets the routeHistorySummary
2. If no route is specified, it looks up the route number of the most recent INPROGRESS route driven by the automobile specified in the auto parameter.
a. If no INPROGRESS route exists, it looks up the name of the driver based on the auto parameter
b. If an INPROGRESS route is found, it looks up the driver based on this route
   3. If a route is specified, it sets the driver based on the route
   4. Calls routeTrackPoint( )

### ListTrackPoints.RouteTrackPoint( )

1. If there is a route to track, it creates a Route object called actualRoute. This object is created in SolrUtil.getActualRoute( ) with line segments loaded in using SolrUtil.getLineSegments( )
2. Using the last point of the actualRoute object, calendar events are found and displayed for the JSON output
3. The List of Routes statusRoutes is created using SolrUtil.getRouteAndStatus( )
4. JSON Statements are added using addPlacesToResult( )
5. JSON Statements are added using addToResult( )
ListTrackPoints.addToResult( )
1. For each route to add to the result, the first and last point are set.
a. If the since parameter includes the entire route, then the first point is set as the origin point. Otherwise, it is set as the ‘currentPoint’ of the first lineSegment that is returned.
   2. The JSON Object is created that contains all of the points on the route. The first point in the JSON array is either the origin point or the currentPoint of the first line segment. This ensures that the route starts in an actual starting location that came from the car GPS data. Similarly, the last point in the JSON array is the destination point, which is defined as the ‘currentPoint’ from the final line segment.
   ListTrackPoints.addPlacesToResult( )
   1. It adds places that were stored in the Route as GEOPlaces around the destination of that route.
   SolrUtil.getActualRoute( )
   1. This method pulls in a list of strings that contains route names and gets a list of routes using the SolrUtil.getLineSegments( ) method.
   2. The Route actualRoute is then set as the first of the list of routes that returned from getLineSegments.
   3. The origin is set using the SolrUtil.getOriginPoint( ) method
   4. Returns Route actualRoute
   SolrUtil.getOriginPoint( ) [[Used to help determine which previous routes to load]]
   1. Uses SolrUtil.getDocsBySPO( ) queries to create an origin GEOPoint by using the hasAsAPointOfOrigin object property
   2. Returns GEOPoint origin
   SolrUtil.getLineSegments( ) [[Used to get route segments of a route]]
   1. Takes in a list of strings with route names. For each route name, a search operation triggers to search SOLR to get the line segments from that route using the hasLineSegment object property
   2. Each of these line segments that are returned from the SOLR query is sent to the SolrUtil.fillInLineSegment( )
   SolrUtil.fillInLineSegment( ) [[Used to fill in the GPS start and end points of route segments]]
   1. Takes in a segment name and a search operation is triggered to search SOLR for the lineSegmentWhen object property
   2. Looks to see if the lineSegment occurred before or after the ‘since’ listTrackPoints parameter
   3. If it occurred after the ‘since’ parameter, then it creates a LineSegment object.
   4. It then stores the start point, end point, and current point in the LineSegment object.

### 5. Returns the LineSegment.

SolrUtil.getRouteAndStatus( )
1. If the events listTrackPoints parameter is true, current and relevant calendar events are found using SolrUtil.getCalendarEvents( ).
2. If the calendar event is near the origin of the route, then that calendar event is not considered. The assumption is that the person has reached that event and restarted their car, therefore creating a new origin that exists at that event.
3. If the event is within 70 minutes of NOW, then an inferred route is added to the Map<String, List,Route>> statusRoutes that is associated with that event.
4. If there is anything null within the actualRoute (either the route is null or there are no line segments), then it returns the statusRoute as it is.
5. Otherwise, it calls SolrUtil.maintainHistory and then SolrUtil.getHistoryAndInferredPoints to get those points. It then adds points of interest with SolrUtil.addPOIS( )
6. Returns the Map<String. List,Route>> statusRoutes.
SolrUtil.getCalendarEvents( )
1. Takes the person who drives the car and uses the personCommitsToEvent object property in a calendar to trigger a search of SOLR for event strings
2. For each event string. SolrUtil.fillInCalendarEvent( ) is used to create a CalendarEvent object.
3. A list of these objects is created and then sorted. The first event on the list (meaning the earliest event in time) is returned
4. Returns a List<CalendarEvent> that contains only the earliest calendar event
SolrUtil.fillInCalendarEvent( )
1. Takes in an event String and triggers a search operation of SOLR for that event Strings event status.
2. If the event is SATISFIED (meaning that the event is near the origin of the route and therefore has already been reached), then it returns null
3. Otherwise, it searches SOLR to get event information and returns it as a CalendarEvent object

### 4. Returns CalendarEvent

SolrUtil.maintainHistory( )
[[Create or provide previous route information that applies to where user is now]]
1. Calls SolrUtil.storeHistory and SolrUtil.removeUnrelatedHistory( )
2. SolrUtil.storeHistory( )
3. Gets the routeHistorySummary from the sessionRouteHistorySummary hash map
4. Gets the origin of the first route from the route history summary to check if it is close to the origin of the current route
5. If the origins are not close, the route history summary is removed from the sessionRouteHistorySummary hash map
6. If this route history summary has been removed or never existed, then a new route history summary is created.
a. A SOLR search for all routes COMPLETED by that driver is returned
b. For each route, if the origin is close to the current routes origin, then the route is added to the route history summary.
   SolrUtil.removeUnrelatedHistory( )
   [[Remove previous route from history that is no longer pertinent to a current route based on one or more parameters such as calendar events, time of day, and distance from the current route]]
   1. If a route history summary exists, it iterates through each route in the history summary
   2. For each route, if the current routes latest line segment exists on that historical route, then the route stays in the history summary. Else, the route is removed from the history summary.
   3. The best route is calculated using the routeHistorySummary.getMaxEntry( ) method.
   4. If the routeTime listTrackPoints parameter is set, then the time that the routes took place is considered in the calculation of max entries.
   SolrUtil.getHistoryAndInferredPoints( ) [[Used to determine inferred route]]
   1. For each route in the route history summary, it determines whether that route has the max entry, where the max entry indicates which route has been taken the most number of times.
   2. If it has the max entry, that route becomes the inferred route, which will eventually be returned by the list track points. Also, for the inferredhistory route, it sets the route name to the inferred routes route name.
a. This is because when the ‘inferred’ route is processed, the route name will eventually be set to be the same as the name for the ‘actual’ route. In order to know which historical route the ‘inferred’ route is referencing, the ‘inferredhistory’ route exists as a placeholder to hold the ‘inferred’ routes route name.
   3. Returns the inferred, historical, and inferredhistory routes.

SolrUtil.addPOIS( ) [[Used to add points of interest to route/destination]]

1. Interests are gathered for the driver using SolrUtil.getPOI( )
a. getPOI uses a google service to get the points of interests
   2. These points are placed in a route using Route.setAroundDestination( )
   3. The route is named based on what route is calling addPOIS( )
   4. The route is added to the statusRoutes in the “inferredPOIs” category

### PointToSegment

1. Takes in a point and calls service to get back line segment
2. If line segments are returned, it takes that single segment or several segments and finds the first segment
3. This first segment gets loaded into a GeoPoint segEnd1 and GeoPoint segEnd2
4. It searches SOLR for the previous line segment. If the previous line segment had segment endpoints that coincide with segEnd1 and segEnd2, then that means it is the same line segment that has already been created, so nothing else happens in the rule.
5. The name of the line segment is checked to see if the new line segment is on the same road as the previous
6. if it is then the old line segment has segEnd1 and segEnd2 appended to it
a. It checks directionality by seeing the later segment point of the previous segment (we will call it segEndB)
   i. It looks to see if segEnd1 or segEnd2 is closer to segEndB. The closer segment end is the earlier segment end in the route.
   ii. If segEnd1 is closer, it receives the time of the current point minus 1 ms, else +1 ms
   iii. Same with segEnd2
      7. if it is not, a new line segment is created for segEnd1 and segEnd2
a. If it there isn't an origin point in SOLR, this point gets designated as the origin point
b. Directionality is decided (and set with the +1/1 ms) by seeing whether the current point is closer to segEnd1 or segEnd2. The one that is closer is the earlier point.

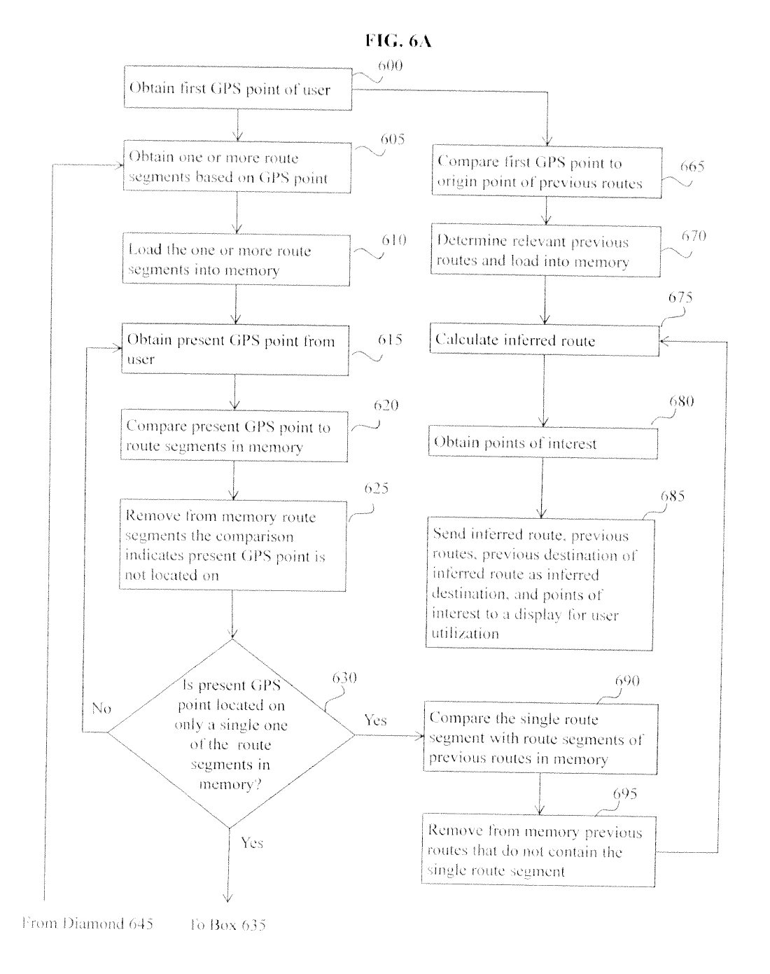

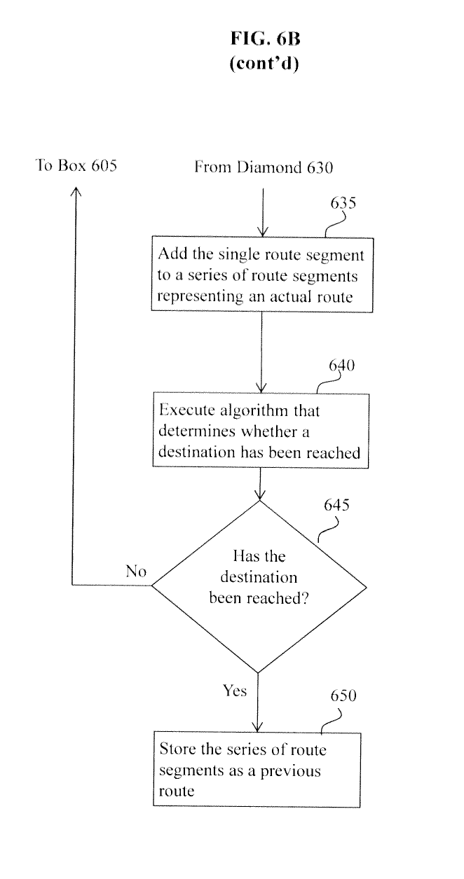

Referring to FIG. 6, embodiments of a process consistent with the invention are disclosed. Block 600 represents a computer operation of obtaining, by one or more computers, via one or more communication networks, a first GPS point of a user.

Block 605 represents a computer operation of obtaining, by the one or more computers, via the one or more communication networks, based on a GPS point obtained most recently, one or more route segments, where a route segment comprises a GPS start point and a GPS end point.

Block 610 represents a computer operation of loading, by the one or more computers, the one or more route segments into memory.

Block 615 represents a computer operation of obtaining, by the one or more computers, via the one or more communication networks, a present GPS point of the user that is subsequent in time to the first GPS point of the user.

Block 620 represents a computer operation of comparing, by the one or more computers, the present GPS point to each of the route segments in memory. For instance, a rectangle may be formed for each of the route segments using the GPS start point and GPS end point of that route segment, and the present GPS point is checked to see whether it falls within the rectangle. The rectangle may be formed by a segment service or by the inference engine.

Block 625 represents a computer operation of removing, by the one or more computers, from memory, each route segment for which results of the comparing operation represented by Block 620 indicate the present GPS point is not located on that route segment.

Diamond 630 represents a computer operation of triggering a repeating of the computer operations represented by Blocks 615-625 and Diamond 630 until Diamond 630 indicates a YES, e.g., results of the comparing operation represented by Block 620 indicate the present GPS point is located on only a single one of the route segments in memory; and triggering a repeating of the computer operations represented by Blocks 690-695 whenever Diamond 630 indicates a YES.

Block 635 represents a computer operation of adding, by the one or more computers, the single route segment as part of a series of route segments representing an actual route.

Block 640 represents a computer operation of executing, by the one or more computers, an algorithm that determines whether a destination has been reached. For example, this algorithm could make the destination determination based on receiving an indication that an automobile engine has been turned off. As another example, this algorithm could make the destination determination based on the number of times a series of present GPS points are all located on a single route segment.

Diamond 645 represents a computer operation of triggering a repeating of the computer operations represented by Blocks 605-640 and Diamonds 630-645 while Diamond 645 indicates NO. e.g., while results of the computer operation represented by Block 640 indicate the destination has not been reached.

Block 650 represents a computer operation of storing, by the one or more computers, as historical user data tagged with provenance, the series of route segments as a previous route in a historical user data datastore.

Block 665 represents a computer operation of comparing, by the one or more computers, the first GPS point of the user with an origin point of each previous route of the user, where a previous route is historical user data of a user comprising a series of route segments in which a GPS end point of one route segment is a GPS start point of another route segment, and where an origin point of a route is a GPS start point of a route segment beginning the series of route segments.

Block 670 represents a computer operation of determining, by the one or more computers, based at least in part on the comparison, a plurality of previous routes whose origin points are within a threshold of the first GPS point of the user, and loading the plurality of previous routes into memory.

Block 675 represents a computer operation of calculating, by the one or more computers, an inferred route, based at least in part on calendar events of the user, time of day, previous routes in memory, number of times each previous route in memory was taken, and/or user preferences.

Block 680 represents a computer operation of obtaining, by the one or more computers, via the one or more communication networks, a plurality of points of interest based on the inferred route and historical user data of the user.

Block 685 represents a computer operation of sending, by the one or more computers, via the one or more communication networks, the inferred route, the previous routes in memory, an inferred destination, which is a route segment ending the series of route segments of the inferred route, and the plurality of points of interest to a display for user utilization.

Block 690 represents a computer operation of comparing, by the one or more computers, the single route segment with the route segments of the inferred route and of each of the previous routes in memory.

Block 695 represents a computer operation of removing, by the one or more computers, from memory any route which does not contain the single route segment; and triggering a repeating of the computer operations represented by Blocks 675-685.

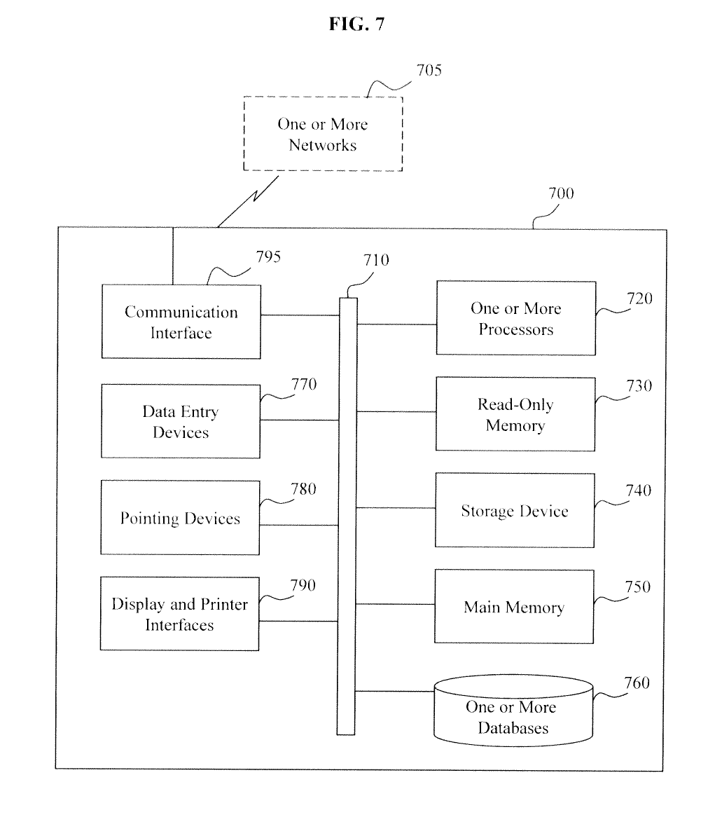

FIG. 7 is a block diagram illustrating embodiments of the system of FIG. 1, generally designated by reference number 700 in FIG. 7. In embodiments, the system 700 according to the present invention may be communicatively coupled to one or more networks 705 via a communication interface 795. The one or more networks 705 may represent a generic network, which may correspond to a local area network (LAN), a wireless LAN, an Ethernet LAN, a token ring LAN, a wide area network (WAN), the Internet, a proprietary network, an intranet, a telephone network, a wireless network, to name a few, and any combination thereof. Depending on the nature of the network employed for a particular application, the communication interface 795 may be implemented accordingly. The network 705 serves the purpose of delivering information between connected parties.

The system 700 may comprise, in some embodiments, a computing platform for performing, controlling, and/or initiating computer-implemented operations, for example, via a server and the one or more networks 705. The computer platform may comprise system computers and other party computers. An exemplary system 700 may operate under the control of computer-executable instructions to carry out the process steps described herein. Computer-executable instructions comprise, for example, instructions and data which cause a general or special purpose computer system or processing device to perform a certain function or group of functions. Computer software for the system 700 may comprise, in embodiments, a set of software objects and/or program elements comprising computer-executable instructions collectively having the ability to execute a thread or logical chain of process steps in a single processor, or independently in a plurality of processors that may be distributed, while permitting a flow of data inputs/outputs between components and systems.

The system 700 may include one or more personal computers, workstations, notebook computers, servers, mobile computing devices, handheld devices such as mobile telephones and PDA's, multi-processor systems, networked personal computers, minicomputers, mainframe computers, personal data assistants, Internet appliances (e.g., a computer with minimal memory, disk storage and processing power designed to connect to a network, especially the Internet, etc.), or controllers, to name a few.

The system 700 may comprise, in embodiments, a bus 710 or other communication component that couples the various system elements 720-795, and is configured to communicate information between the various system elements 720-795.

As shown in FIG. 7, one or more computer processors 720 may be coupled with the bus 710 and may be configured to process and handle information and execute instructions. The system 700 may include a main memory 750, such as a Random Access Memory (RAM) or other dynamic storage device, coupled to the bus 700, for storing information and instructions to be executed by the one or more processors 720. The main memory 750 also may be used for storing temporary variables or other intermediate information during execution of instructions by the one or more processors 720.

The system 700 further may include a Read-Only Memory (ROM) 730 or other static storage device (e.g., EPROM, EAROM, EEPROM, PROM, flash, and the like) coupled to the bus 710 for storing static information and instructions for the one or more processors 720. Furthermore, a storage device 740, such as a magnetic disk or optical disk, such as a CD-ROM or other optical media may be provided and coupled to the bus 710 for storing information and instructions.

In addition to the ROM 730, one or more databases 760 may be coupled to the bus 710 for storing static information and software instructions. Information stored in or maintained in the database 760 may be provided in conformance with a database system format such as, but not limited to, the Structured Query Language (SQL) format. Database query and access instructions, for example, in the form of one or more scripts, may be used which, when executed by a processor such as the processor 720, serve to access, store and retrieve data maintained in the database 760 according to the instructions contained in the script.

Furthermore, the system 700 may comprise application software instructions which may implement a user interface portion for generating interactive pages or display screens by which a user/participant may provide data to and receive information from the system 700 and the database 760 using a human-machine interface. In embodiments, interactive pages may include user dialog boxes for accepting user entered information. In particular, the human-machine interface may comprise a Graphical User Interface (GUI) portion for prompting the user to enter data by providing an interactive dialog box or message box instructing the user to enter particular data, or to select from among a multitude of options provided using a pull-down menu. In embodiments, a user may interact with the system 700 via the graphical user interface by using a pointing device and/or data entry device. The GUI portion may place the output of the system 700 in a format for presentation to a user via the display. In embodiments, the GUI may be implemented as a sequence of Java instructions.

A data entry device 770, including alphanumeric and other keys, or a pointing device such as a mouse or trackball, or a scanner, to name a few, may be coupled to the bus 710 for communicating information and command selections to the processor 720. The data entry device 770 may be coupled to the bus 710 via an interface (not shown), wherein the interface may be, for example, a serial port, an RS-232 port, or the like. In addition, the interface may be a wireless interface and provide connection-less communication via, for example, Bluetooth communication.

The system 700 may be coupled via the bus 710 to a display or printer 790 for outputting information to a computer user. In addition, a user may use the display (e.g., touch screen) or a scanner to provide information to the system 700.

In embodiments of the present invention, the various program operations as described herein may be provided by the system 700 in response to the one or more processors 720 executing one or more sequences of computer-readable instructions contained in the main memory 750. Such instructions may be read into the main memory 750 from another computer-readable medium, such as the ROM 730, the storage device 740, or the database 760. Execution of the sequences of instructions contained in the main memory 750 may cause the one or more processors 720 to perform the process steps described herein. It should be appreciated that embodiments of the system 700 may perform fewer or additional processes as compared to those described herein. As noted, the one or more processors 720 may be arranged in a multi-processing arrangement. In embodiments, hard-wired circuitry may be used in place of or in combination with software instructions to implement the invention. Thus, embodiments of the invention are not limited to any specific combination of hardware circuitry and software.

The term “computer-readable medium” or “computer-readable storage medium,” as used herein refers to any medium that is computer-readable and participates in storing and providing instructions to the processor 720 for execution. Such a medium may be removable or non-removable and may take many forms, including, but not limited to, non-volatile media and volatile media. Non-volatile media include, for example, optical or magnetic disks, such as the storage device 740. Volatile media include dynamic memory, such as the main memory 750. Common forms of computer-readable media include, for example, floppy disk, a flexible disk, hard disk, magnetic tape, any other magnetic medium, a Compact Disc Read Only Memory (CD ROM), Digital Video Disc (DVD) or any other optical medium, punch cards, paper tape, any other physical medium with patterns of holes, a Random Access Memory (RAM), a Programmable Read Only Memory (PROM), an Erasable Programmable Read Only Memory (EPROM), a Flash EPROM, any other memory chip or cartridge, or any other tangible medium from which a computer can read computer instructions. Combinations of the above are also included within the scope of machine-readable media. Machine-executable instructions comprise, for example, instructions and data which cause a general purpose computer, special purpose computer, or a special purpose processing machine to perform a certain function or group of functions. It should be appreciated that the one or more databases 760, the main memory 750, the storage device 740, and the ROM 730 may, in some embodiments, be described as a “computer-readable medium” or a “computer-readable storage medium.”

As previously noted, the system 700 also comprises a communication interface 795 coupled to the bus 710 for providing one-way, two-way or multi-way data communication with the network 705, and/or communication directly with other devices. In embodiments, the communication interface 795 may comprise a modem, a transceiver Integrated Services Digital Network (ISDN) card, a WAN card, an Ethernet interface, or the like, to provide a data communication connection to a corresponding type of communication medium. As another example, the communication interface 795 may comprise a LAN card to provide a data communication connection to a compatible LAN. Wireless links may also be implemented. In such wireless links, the communication interface 795 may communicate with a base station communicatively coupled to a network server. In any such implementation, the communication interface 795 sends and receives electrical, electromagnetic, radio, infrared, laser, or optical signals that carry digital data streams representing various types of information. Any combination of the above interfaces may also be implemented.

In embodiments, the communication interface 795 may be communicatively coupled to a web server configured in the one or more processors 720 to generate and output web content that is suitable for display using a web browser at a computing device. In embodiments, the server may generate and transmit requested information through the communication interface 795 to a requesting terminal via Hypertext Transfer Markup Language (HTML) formatted pages, eXtensible Markup Language (XML) formatted pages, or the like, which may be provided as World Wide Web pages that may enable navigation by hyperlinks. The server program may be used to receive commands and data from clients' terminals, access and process data from various sources, and output computer-executable instructions and data using the network 705. Interactive pages transmitted and received using the network 705 may conform to necessary protocols.

The web server configured in the one or more processors 720, in embodiments, may correspond to a secure web application server behind a web server program that a service provider employs to run one or more web based application programs (e.g., an application program to carry out the methods described above) in a secure fashion. Such a secure web application server may be configured to execute one or more web based application programs, responsive to commands and data received from the clients (via a web page supported by the web server), and providing data and results to the clients. The web server and the web application server may be implemented using a single computing platform. Alternatively, it may also be implemented using multiple separate and distributed computing platforms.

As noted above, embodiments of the present invention may be practiced in a networked environment using logical connections to one or more remote computers having processors. Logical connections may include a local area network (LAN) and a wide area network (WAN) that are presented here by way of example and not limitation. Such networked environments are in office-wide or enterprise-wide computer networks, intranets and the Internet, and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Embodiments of the invention have been described in the general context of method steps which may be implemented in embodiments by a program product including machine-executable instructions, such as program code, for example in the form of program modules executed by machines in networked environments. Generally, program modules include routines, programs, objects, components, data structures, etc., that perform particular tasks or implement particular data types. Multi-threaded applications may be used, for example, based on Java or C++. Machine-executable instructions, associated data structures, and program modules represent examples of program code for executing steps of the methods disclosed herein. The particular sequence of such executable instructions or associated data structures represent examples of corresponding acts for implementing the functions described in such steps.

It should be noted that although the flow charts provided herein and the claims show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention may be accomplished with programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations.

All components, modes of communication, and/or processes described heretofore are interchangeable and combinable with similar components, modes of communication, and/or processes disclosed elsewhere in the specification, unless an express indication is made to the contrary. It is intended that any structure or step of an embodiments disclosed herein may be combined with other structure and or method embodiments to form further embodiments with this added element or step

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A non-transitory computer-readable medium with computer instructions therein for generating entailments when the computer instructions are executed by one or more computers, the computer instructions comprising the steps:
(a) obtaining, by the one or more computers, via one or more communication networks, input data of a user comprising one or more selected from the group of calendar events, GPS data, social network activity, search queries, and user preferences, where the input data may be semantically structured and/or non-semantically structured;
(b) comparing, by the one or more computers, the input data to a group of term sets, where a term set comprises one or more selected from the group of key words, definitions, and relationships for an area of interest;
(c) determining, by the one or more computers, based at least in part on results of the comparing step, selected terms, where the selected terms comprise a plurality of key words and/or definitions and/or relationships from the group of term sets, and loading the selected terms into memory, which is non-persistent;
(d) selecting, by the one or more computers, based at least in part on the selected terms and the input data, a plurality of inference rules from a rules resource, and loading the plurality of inference rules into the memory;
(e) selecting, by the one or more computers, based at least in part on the selected terms and the plurality of inference rules from a historical user data datastore, a subset of historical user data comprising past input data of the user and previously generated entailments of the user, where an entailment is an automatically-machine-generated conclusion of an inference rule, and loading the subset of the historical user data into the memory;
(f) generating by firing one or more of the inference rules, using a rules engine configured in the one or more computers, one or more new entailments based at least in part on the input data, the subset of historical user data, the selected terms, and the inference rules;
(g) when a new entailment is generated, repeating steps (a)-(f), for each entailment generated, treating the new entailment as input data in the performance of the steps;
(h) storing or having stored, by the one or more computers, in the historical user data datastore as historical user data of the user, the input data and all new entailments;
(i) obtaining, by the one or more computers, via the one or more communication networks, output data comprising one or more from the group of points of interest along a route, predictive routes, and inferred destinations, based at least in part on the input data, the new entailments, the subset of historical user data, and GPS data; and
(j) sending or having sent, by the one or more computers, via the one or more communication networks, the output data to a display for user utilization.

2. The non-transitory computer-readable medium as defined in claim 1, wherein the input data comprises three or more selected from the group of calendar events, GPS data, social network activity, search queries, and user preferences.

3. The non-transitory computer-readable medium as defined in claim 1, wherein the input data comprises all from the group of calendar events, GPS data, social network activity, search queries, and user preferences.

4. The non-transitory computer-readable medium as defined in claim 1, wherein the term set comprises key words, definitions, and relationships for an area of interest.

5. The non-transitory computer-readable medium as defined in claim 1, wherein the selected terms comprise key words, definitions, and relationships from the group of term sets.

6. The non-transitory computer-readable medium as defined in claim 1, further comprising instantiating, by the one or more computers, semantically structured input data, based at least in part on the selected terms and non-semantically-structured input data.

7. The non-transitory computer-readable medium as defined in claim 1, wherein the input data and all new entailments stored as historical user data of the user are tagged with provenance.

8. The non-transitory computer-readable medium as defined in claim 1, wherein the output data further comprises one or more from the group of calendar event reminders and reordered search results, obtained by the one or more computers, based at least in part on the input data, the new entailments, the subset of historical user data, and the GPS data.

9. The non-transitory computer-readable medium as defined in claim 1, wherein the GPS data comprises route segment data, wherein a route segment comprises a GPS start point and a GPS end point.

10. A non-transitory computer-readable medium with computer instructions therein for creating a route when the computer instructions are executed by one or more computers, the computer instructions comprising the steps:
(a) obtaining, by one or more computers, via one or more communication networks, a first GPS point of a user;
(b) obtaining, by the one or more computers, via the one or more communication networks, based on a GPS point obtained most recently, one or more route segments, where a route segment comprises a GPS start point and a GPS end point;
(c) loading, by the one or more computers, the one or more route segments into memory;
(d) obtaining, by the one or more computers, via the one or more communication networks, a present GPS point of the user that is subsequent in time to the first GPS point of the user;
(e) comparing, by the one or more computers, the present GPS point to each of the route segments in memory;
(f) removing, by the one or more computers, from memory, each route segment for which results of the comparing step of (e) indicate the present GPS point is not located on that route segment;
(g) repeating steps (d)-(g), until results of the comparing step of (e) indicate the present GPS point is located on only a single one of the route segments in memory;
(h) adding, by the one or more computers, the single route segment as part of a series of route segments representing an actual route;
(i) executing, by the one or more computers, an algorithm that determines whether a destination has been reached;
(j) repeating steps (b)-(j), while results of the executing step of (i) indicate the destination has not been reached; and
(k) storing or having stored, by the one or more computers, as historical user data tagged with provenance, the series of route segments as a previous route in a historical user data datastore.

11. The non-transitory computer-readable medium as defined in claim 10, further comprising:
(n) comparing, by the one or more computers, the first GPS point of the user with an origin point of each previous route of the user, where a previous route is historical user data of a user comprising a series of route segments in which a GPS end point of one route segment is a GPS start point of another route segment, and where an origin point of a route is a GPS start point of a route segment beginning the series of route segments;
(o) determining, by the one or more computers, based at least in part on the comparison, a plurality of previous routes whose origin points are within a threshold of the first GPS point of the user, and loading the plurality of previous routes into memory;
(p) calculating, by the one or more computers, an inferred route, based at least in part on calendar events of the user, time of day, previous routes in memory, number of times each previous route in memory was taken, and/or user preferences;
(q) obtaining, by the one or more computers, via the one or more communication networks, a plurality of points of interest based on the inferred route and historical user data of the user;
(r) sending, by the one or more computers, via the one or more communication networks, the inferred route, the previous routes in memory, an inferred destination, which is a route segment ending the series of route segments of the inferred route, and the plurality of points of interest to a display for user utilization;
(s) comparing, by the one or more computers, the single route segment with the route segments of the inferred route and of each of the previous routes in memory;
(t) removing, by the one or more computers, from memory any route which does not contain the single route segment; and repeating steps (p)-(r); and
(u) repeating steps (s)-(t) whenever results of the comparing step of (e) indicate the present GPS point is located on only a single one of the route segments in memory.

12. A system for generating entailments comprising:
one or more computers configured to:
(a) obtain, using an input component configured in the one or more computers, via one or more communication networks, input data of a user comprising one or more selected from the group of calendar events, GPS data, social network activity, search queries, and user preferences, where the input data may be semantically structured and/or non-semantically structured;
(b) compare, using a comparator configured in the one or more computers, the input data to a group of term sets, where a term set comprises one or more selected from the group of key words, definitions, and relationships for an area of interest;
(c) determine, using a term selector configured in the one or more computers, based at least in part on results of the comparing step, selected terms, where the selected terms comprise a plurality of key words and/or definitions and/or relationships from the group of term sets, and loading the selected terms into memory, which is non-persistent;
(d) select, using an inference rule selector configured in the one or more computers, based at least in part on the selected terms and the input data, a plurality of inference rules from a rules resource, and loading the plurality of inference rules into the memory;
(e) select, using a historical data selector configured in the one or more computers, based at least in part on the selected terms and the plurality of inference rules from a historical user data datastore, a subset of historical user data comprising past input data of the user and previously generated entailments of the user, where an entailment is an automatically-machine-generated conclusion of an inference rule, and loading the subset of the historical user data into the memory;
(f) generate by firing one or more of the inference rules, using a rules engine configured in the one or more computers, one or more new entailments based at least in part on the input data, the subset of historical user data, the selected terms, and the inference rules;
(g) when a new entailment is generated, repeat steps (a)-(f), for each entailment generated, treating the new entailment as input data in the performance of the steps;
(h) store or have stored, by the one or more computers, in the historical user data datastore as historical user data of the user, the input data and all new entailments;
(i) obtain, by the one or more computers, via the one or more communication networks, output data comprising one or more from the group of points of interest along a route, predictive routes, and inferred destinations, based at least in part on the input data, the new entailments, the subset of historical user data, and GPS data; and
(j) send or have sent, by the one or more computers, via the one or more communication networks, the output data to a display for user utilization.

13. The system as defined in claim 12, wherein the input data comprises three or more selected from the group of calendar events, GPS data, social network activity, search queries, and user preferences.

14. The system as defined in claim 12, wherein the input data comprises all from the group of calendar events, GPS data, social network activity, search queries, and user preferences.

15. The system as defined in claim 12, wherein the selected terms comprise key words, definitions, and relationships from the group of term sets.

16. The system as defined in claim 12, wherein the GPS data comprises route segment data, wherein a route segment comprises a GPS start point and a GPS end point.

17. A system for creating a route when the computer instructions are executed, comprising:
one or more computers, configured with computer instructions to:
(a) obtain, by the one or more computers, via one or more communication networks, a first GPS point of a user;
(b) obtain, by the one or more computers, via the one or more communication networks, based on a GPS point obtained most recently, one or more route segments, where a route segment comprises a GPS start point and a GPS end point;
(c) load, by the one or more computers, the one or more route segments into memory;
(d) obtain, by the one or more computers, via the one or more communication networks, a present GPS point of the user that is subsequent in time to the first GPS point of the user;
(e) compare, by the one or more computers, the present GPS point to each of the route segments in memory;
(f) remove, by the one or more computers, from memory, each route segment for which results of the comparing step of (e) indicate the present GPS point is not located on that route segment;
(g) repeat steps (d)-(g), until results of the comparing step of (e) indicate the present GPS point is located on only a single one of the route segments in memory;
(h) add, by the one or more computers, the single route segment as part of a series of route segments representing an actual route;
(i) execute, by the one or more computers, an algorithm that determines whether a destination has been reached;
(j) repeat steps (b)-(j), while results of the executing step of (i) indicate the destination has not been reached; and
(k) store or have stored, by the one or more computers, as historical user data tagged with provenance, the series of route segments as a previous route in a historical user data datastore.

18. The system as defined in claim 17, further comprising the one or more computers configured to:
(n) compare, by the one or more computers, the first GPS point of the user with an origin point of each previous route of the user, where a previous route is historical user data of a user comprising a series of route segments in which a GPS end point of one route segment is a GPS start point of another route segment, and where an origin point of a route is a GPS start point of a route segment beginning the series of route segments;
(o) determine, by the one or more computers, based at least in part on the comparison, a plurality of previous routes whose origin points are within a threshold of the first GPS point of the user, and loading the plurality of previous routes into memory;
(p) calculate, by the one or more computers, an inferred route, based at least in part on calendar events of the user, time of day, previous routes in memory, number of times each previous route in memory was taken, and/or user preferences;
(q) obtain, by the one or more computers, via the one or more communication networks, a plurality of points of interest based on the inferred route and historical user data of the user;
(r) send, by the one or more computers, via the one or more communication networks, the inferred route, the previous routes in memory, an inferred destination, which is a route segment ending the series of route segments of the inferred route, and the plurality of points of interest to a display for user utilization;
(s) compare, by the one or more computers, the single route segment with the route segments of the inferred route and of each of the previous routes in memory;
(t) remove, by the one or more computers, from memory any route which does not contain the single route segment; and repeating steps (p)-(r); and
(u) repeat steps (s)-(t) whenever results of the comparing step of (e) indicate the present GPS point is located on only a single one of the route segments in memory.

19. A method for generating entailments, comprising:
(a) obtaining, by one or more computers, via one or more communication networks, input data of a user comprising one or more selected from the group of calendar events, GPS data, social network activity, search queries, and user preferences, where the input data may be semantically structured and/or non-semantically structured;
(b) comparing, by the one or more computers, the input data to a group of term sets, where a term set comprises one or more selected from the group of key words, definitions, and relationships for an area of interest;
(c) determining, by the one or more computers, based at least in part on results of the comparing step, selected terms, where the selected terms comprise a plurality of key words and/or definitions and/or relationships from the group of term sets, and loading the selected terms into memory, which is non-persistent;
(d) selecting, by the one or more computers, based at least in part on the selected terms and the input data, a plurality of inference rules from a rules resource, and loading the plurality of inference rules into the memory;
(e) selecting, by the one or more computers, based at least in part on the selected terms and the plurality of inference rules from a historical user data datastore, a subset of historical user data comprising past input data of the user and previously generated entailments of the user, where an entailment is an automatically-machine-generated conclusion of an inference rule, and loading the subset of the historical user data into the memory;
(f) generating by firing one or more of the inference rules, using a rules engine configured in the one or more computers, one or more new entailments based at least in part on the input data, the subset of historical user data, the selected terms, and the inference rules;
(g) when a new entailment is generated, repeating steps (a)-(f), for each entailment generated, treating the new entailment as input data in the performance of the steps;
(h) storing or having stored, by the one or more computers, in the historical user data datastore as historical user data of the user, the input data and all new entailments;
(i) obtaining, by the one or more computers, via the one or more communication networks, output data comprising one or more from the group of points of interest along a route, predictive routes, and inferred destinations, based at least in part on the input data, the new entailments, the subset of historical user data, and GPS data; and
(j) sending or having sent, by the one or more computers, via the one or more communication networks, the output data to a display for user utilization.
